(19) United States
(12) Patent Application Publication
(10) Pub. No.: US 2008/0120335 A1
(43) Pub. Date: May 22, 2008

(54) Environmental Control System and Method

(76) Inventor: Alexei Dolgoff, Berekely, CA (US)

Correspondence Address: ALEXEI DOLGOFF, 14 TAMALPAIS RD., BERKELEY, CA, 94708, US

(21) Appl. No.: 10/580,634

(22) PCT Filed: Oct. 31, 2002
(86) PCT No.: PCT/US02/34983

§ 371 Date: Jul. 2, 2007

Related U.S. Application Data
(60) Provisional application No. 60/336,276, filed on Oct. 31, 2001.

(51) Int. Cl. G06F 17/30; G06F 17/00; G06F 3/048

(52) U.S. Cl. 707/104.1; 700/117; 715/771; 707/E17.009

(57) ABSTRACT

The sensors dialog box (100) can be used to serve two purposes, according to a preferred embodiment of the present invention. First, it can allow the user to specify and change most of the settings of the sensors used in the system. When the user selects a sensor from the list of available sensors (1002), the rest of the sensors dialog (100) fills with information that describes and relates to the selected sensor. The name, type calibration, and check period of the sensor can be entered into the edit boxes (1004), in the preferred embodiment, manual entry can occur as long as the sensor is not linked to the calendar from the sensor log generator dialog box. This embodiment can also include an apply button (1006) and change sensor color for graphics button (1008). When the sensor is of type “EQUATION”, the information in an equation window (1010) will be parsed to tell the program how to interpret what the reading of the sensor is at any given time.

### FIELD OF THE INVENTION

The present invention relates generally to an environmental control system, and more specifically to a hardware and software package that controls environmental and other (such as any yield-related, etc.) conditions, such as those in greenhouses.

### BACKGROUND OF THE INVENTION

Many methods and systems for controlling environmental conditions, such as those involved with smaller-scale farming, involve rudimentary means of controlling the various environmental conditions, the steps of the growing process, and the mechanical (i.e, computer, electrical, circuits, devices, etc.) related functionality of the system. The yield and efficiency of an operation can vary greatly in response to changes in environmental parameters. Current systems can not adjust system settings in real time based upon data collected about such environmental parameters; the human operator is required to evaluate the data and change the settings.

Additionally, many such control systems are valued between $10,000 and $100,000 each and are not affordable for hobbyists and smaller-scale farmers. Furthermore, many present control methods and systems are unable to perform sophisticated analysis of data collected in connection with when other farming necessities were being accomplished. With the tremendous increases and advantages that are accessible via all of the modern advances in horticultural science, such as crop yield, plant benefit (resiliency, potency, etc.), knowledge and use of the most sophisticated level of parameters is an invaluable requirement for maximization of efficiency and profit. For example, in situations where small-scale farmers desire exacting environmental information or control parameters as quickly as possible, and without any unnecessary hardship (i.e., a farmer in Holland comparing his environmental control regime with another farmer is Australia via the World Wide Web), knowledge of parameters such as precisely monitored environmental conditions, climates that have successfully provided the desired crop and data that is a function of various known information are required to provide the most useful results. Not only do these parameters vary greatly from customer to customer, but they can also include information as to how the benefits of one customer correspond to those of another. Prior environmental control systems are characterized by several impracticalities, such as unreasonable monetary expense and other drawbacks such as lack of integration of these parameters into daily (and even to the hour, minute and second) operations.

Environmental control systems are valued between $10,000 and $100,000 each and are not affordable for hobbyists and small-scale farmers. These systems are designed for very specific applications, are often not easy to use, and often require an onsite consultant for the buyer to use the product. This great cost puts these types of systems out of range for more small-scale users, do-it-yourself type of clientele, or even many mid-range operations that require numerous different environments. There is need for a product that has been designed with a smaller budget in mind; one which has the lowest cost yet most reliable parts. Up to this point, systems did not exist that could be used for wide variety of farming or that were easy to use, affordable and reliable. A system available at sufficiently low price could be successfully marketed by retailers to a large number of customers that desire precisely such environmental control system.

Regardless of the size of the environmental control system involved, however, the manipulated parameters must be useful to the customer and helpful for the crop at hand to ensure continued success of the applicable environmental control system. By way of brief example, current systems are designed for a particular use, such as to control a hydroponic growing environment (e.g., cultures for the pharmaceutical industry), or for a particular crop like grapes in the agricultural industry. In such environments, current methods and systems are frequently unsatisfactory due to the lack of information provided (i.e., in specificity, etc.), the inefficient or otherwise problematic functionality of acquiring information, as well as the lack of appropriate processes to take advantage of all available information. In such ways, current systems and methods of controlling environments are generally unable to provide the usefulness, flexibility, and customer-specific advantages (see below) required to efficiently and effectively provide the satisfactory results necessary for today's small- to mid-scale farming/horticultural users to take advantage of modern technology and sophisticated processes.

### SUMMARY AND ADVANTAGES OF THE INVENTION

A hardware and software system to design and control environments, which can also include a means of intelligent, flexible process control. Additionally, the following statements in this paragraph summarize further preferred embodiments of the present invention. A virtual environmental control workshop or studio that provides users with all the logical tools they should ever need, on a platform that they can structure or restructure dynamically to suit their individual needs, regardless of the application. A system of defining abstract linkage between sensors, virtual sensor values, devices and/or virtual devices, so that a computer, aided by logical settings, interrelationship properties and rules, and variables calculated for statistics, can perform actions that it determines may remedy a situation which is out of a tolerance level of what the computer user has informed it is desirable. Also a system of pre-programming dynamic or static behavior patterns, such as timed intervals of device usage, changing control regimes, and decisions which will be made at future time in a way that will depend on the state of readings and variables at that time. A means of capturing and replaying environmental conditions over long and short periods of time. A multi-media authoring and control package that has upgradeable hardware and software components, and can be adapted to handle virtually all electronic sensors, and switch virtually all electric devices. A means of collecting, generating and sharing digital log files (transferable by electronic means such as the internet or a network), which can be used by the system to play back a certain environment. A system that can be controlled, reconfigured, or completely restructured from afar, via a network, the internet, by telephone, or other electronic means. A means of cataloging information in a meaningful, organized way, to aid comprehension of conditions noticed in an environment, or group of environments. A novel graphical user interface that enhances and simplifies comprehension of readings, device states, variables, text notes, pictures, other values, and how they relate to each other, as well as settings and the current, past, and future status of an environment.

It is an advantage of one or more embodiments of the present invention to create linkage (including, for example, abstract linkages) between sensors, virtual sensor values, devices and/or virtual devices, so that a computer, aided by logical settings, interrelationship properties and rules, and variables calculated for statistics, can perform actions that it determines may remedy a situation which is out of a tolerance level of what the computer user has informed it is desirable. In the presently preferred embodiment, the user: (1) supplies the computer with information and means for collecting and interpreting information, and (2) tells the computer not only what tools it has available for use, but also what a human operator might be able to determine or desire in certain circumstances; the computer then operates to accomplish those priorities.

It is an advantage of one or more embodiments of the present invention to provide low-cost environmental control to agriculturists particularly small-scale agriculturists), in order for them to improve efficiency, decrease resource consumption, and increase yields.

It is another advantage of one or more embodiments of the present invention to give managers of environmental controlled agriculture a high-technology tool that allows management decisions to be made using empirical environmental information, which can be defined by variables and/or recorded at all times; as one distinct advantage, this can enhance managers understanding of how a wide variety of factors influence one another. Management decisions, and the logical arrangements behind the decision making can be plugged back into the program so as to see the desired outcome without having the user physically located at the environment to be controlled.

It is an advantage of one or more embodiments of the present invention to allow the user to create their own variables in order to track things of importance to them for their art.

It is yet another advantage of one or more embodiments of the present invention to use the computer to more accurately control environments using fewer man-hours to achieve this accuracy, due to the program's ability to make complex decisions based upon its initial set-up—leaving the operator free to do other tasks.

It is still another advantage of one or more embodiments of the present invention to be flexible enough to be used in a wide variety of applications, in that it is not limited to only a certain type of set-up for a certain crop or environment, but it is able to be easily set-up to control any controlled environment system, such as: greenhouses, hydroponics, greyhouses, and other controlled environments.

It is another advantage of one or more embodiments of the present invention to offer remote accessibility to be able to change all of the parameters of the program from afar, via phone lines, PDAs, over the Internet, and/or by any tele- (or other) communication linkage.

It is yet another advantage of one or more embodiments of the present invention to be upgradeable with all the latest software features, via new software (i.e., on disk, CD-ROM, etc.) or via the World Wide Web, making it a more durable product.

It is another advantage of one or more embodiments of the present invention to employ virtually as complex logic schemes as deemed necessary by the user to control the environmental factors in the desired way. This is accomplished through the ability to use logic to create sensors or devices that are not real, in the sense that they are derived, encapsulated, or interrelated to other sensors or variables, thereby increasing flexibility of the system.

It is still another advantage of one or more embodiments of the present invention to be able to use any physical sensor because of the ability of the software to affect and interpret any sensor's electrical signal through user defined equations and mathematical logic, and therefore convert it's electrical output into any units necessary, and use it's value in derivative sensors or variables. The invention will also be able to control any physical device that runs on electrical current, or alert the user if a non electrical device or action needs to be operated at a certain time.

It is still another advantage of one or more embodiments of the present invention to provide an easy-to-use graphical user interface, which gives any user the ability to utilize any of the features in a readily apparent manner, making for simplified use.

It is another advantage of one or more embodiments of the present invention to be used to control all aspects of an environmental controlled system from a single, main unit, whereby the logic functionality is able to control all of the devices from sensor input.

It is yet another advantage of one or more embodiments of the present invention to record all of the information collected from the electrical inputs and outputs so that the exact same instance can be replayed, thereby providing the ability to repeat successful situations/environments and further simplifying decision making.

It is another advantage of one or more embodiments of the present invention to have the ability to sound an alarm, when the desired parameters are not being met, through a variety of ways, such as via sound, email, pager, and/or phone.

It is still another advantage of one or more embodiments of the present invention to track the amount of energy used by each device and to furnish the watt hours used in order that electrical consumption can be minimized.

Other advantages, features, and objects of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicates similar elements, and in which:

FIG. 1 illustrates a diagram of an environmental control system, according to one embodiment of the present invention;

FIG. 2 illustrates a block diagram of a computer system used for controlling environments, according to one embodiment of the present invention;

FIG. 3 illustrates a diagram of an environmental control system showing some process steps, according to one embodiment of the present invention;

FIG. 4 illustrates a diagram of a computer and sensor system portion of the invention, according to one embodiment of the present invention;

FIG. 5 illustrates an exemplary greenhouse system portion of the invention, according to one embodiment of the present invention;

FIG. 6 is an illustration of a graphical user interface (“GUI”) that shows a main program GUI of an exemplary greenhouse control system, according to a preferred embodiment of the present invention;

FIG. 7 is an illustration of a GUI that shows a sensor views dialog box, associated with the main program GUI of FIG. 6, according to one embodiment of the present invention;

FIG. 8 is an illustration of a GUI that shows a properties for sensor view dialog box, associated with the main program GUI of FIG. 6, according to one embodiment of the present invention;

FIG. 9 is an illustration of a GUI that shows a network readout dialog box, associated with the main program GUI of FIG. 6, according to one embodiment of the present invention;

FIG. 10 is an illustration of a GUI that shows a sensors dialog box, associated with the main program GUI of FIG. 6, according to one embodiment of the present invention;

FIG. 11 is an illustration of a GUI that shows a sensor log generator and settings dialog box, associated with the main program GUI of FIG. 6, according to one embodiment of the present invention;

FIG. 12 is an illustration of a GUI that shows a log file template manager dialog box, associated with the main program GUI of FIG. 6, according to one embodiment of the present invention;

FIG. 13 is an illustration of a GUI that shows a first virtual sensors dialog box, associated with the main program GUI of FIG. 6, according to one embodiment of the present invention;

FIG. 14 is an illustration of a GUI that shows a second virtual sensors dialog box, associated with the main program GUI of FIG. 6, according to one embodiment of the present invention;

FIG. 15 is an illustration of a GUI that shows a third virtual sensors dialog box, associated with the main program GUI of FIG. 6, according to one embodiment of the present invention;

FIG. 16 is an illustration of a GUI that shows a devices properties and manual override dialog box, associated with the main program GUI of FIG. 6, according to one embodiment of the present invention;

FIG. 17 is an illustration of a GUI that shows a virtual devices control dialog box, associated with the main program GUI of FIG. 6, according to one embodiment of the present invention; and

FIG. 18 is a flow chart illustrating an exemplary environmental control system control process sequence, according to one embodiment of the present invention.

### DETAILED DESCRIPTION OF THE INVENTION

### I. Main Description

A system and method for controlling environments is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

While the following description does not always contain the indication that the description refers to embodiments of the present invention (as opposed to description that refers to universal characteristic(s) of all embodiments of the present invention), it is hereby noted that all written and illustrated description of the invention contained herein is deemed to be qualified with “according to one embodiment of the present invention . . . ” or the equivalent, such that the invention, the claimed inventions and different applications of the present invention are not limited by the specific examples recited throughout. Essentially, recitation of qualification such as “according to this embodiment of the present invention” has not been added at every desired point in the specification for this provisional application; however, we note here that this provisional application should be read and understood to contain such qualification in connection with every sentence, phrase and figure disclosed.

The product is a hardware and software package that controls environmental conditions such as greenhouses, greyhouses, and hydroponics all used for the growing of a variety of agricultural products. Most operations rely on fixed status systems. In other words, each device is controlled with a independent system that has a control module of varying complexity, with or without a microprocessor based control system. An example is a thermostat, which controls the heat level in a house. The operator of the system is typically required to set and reset the “set-point” in degrees Fahrenheit of each controller to adjust the behavior of a heater. Our system can encapsulate these independent systems, by either supplying power to the independent system or not. For example, our autoclave is pressurized by a boiler, that has a fixed system that will maintain a pressure of up to 15 PSI. We can add our own pressure sensor to the pressure vessel, and if we want to maintain any value between 0 and 15 PSI, we supply power to the independent controller on the boiler and then shut it off at the right PSI. The independent systems are not necessary, but are an excellent safeguard to our system. A pressure vessel of the type that we use is not ever meant to reach higher than 15 PSI, so we can be extra sure of this fact. Since most operations already have the devices they use to control their environments, our product provides a flexible way of encapsulating whatever setup is currently controlling an operation. All that is required is a new set of sensors and relays that will then control the devices already in use.

One of the many novel, unique, and innovative things about this invention is that it performs many duties usually handled by the human operators of the electrical components, and can also perform many managerial operations. A worker is then able to spend more of his or her valuable time studying the effectiveness of the system, and adjusting the settings to increase efficiency and productivity. Our system has the computer do the equivalent of what would be the effect of a dedicated worker sitting at each fixed status system, checking the status every 15 seconds. The worker and the computer would then make logical decisions depending on the state of the operation, and the conditions sensed at that site and on the entire operation and re-adjust the set point at the same time. Also, the system contains powerful timers which can be used in conjunction with sensor input, to provide sophisticated decision making without a human operator on hand at all times.

Not only does the system have the ability to adjust itself through complex logical decisions in real time, but also it records the state of the devices and all sensor readings every fifteen seconds. This information is available in an innovative graphical user interface, which makes it easy for the operator to see sensor and device information in relation to each other, in whatever combination makes the most sense. This way, only relevant information is displayed at a time, depending on which view configuration is set-up and selected by the user. Finally, the user can at any time use simple graphical user interface tools like draw, cut, copy, and paste, to create or to playback a successful set of conditions that was seen over a time range or any new set of desired conditions. If for example, a high yield was noticed during a time period, the user could play back that file. This would be similar to a person recording music off the radio, and hearing a song they liked. Afterwards, when they wanted to hear it again, they would simply hit “play”. We intend to offer these files on a web site, where users could share their most successful files, and provide each other with support and feedback. The files might be examples of highly energy, and or resource efficient setups, or ones that provide higher crop yield, or maybe even the least susceptible to pest damage. The user could then pick a combination that has various levels of the factors they care about most.

In addition to these on site features, the system has a broad range of remote control features. Included RAS (remote automated server) support means that an operator can make a telephone call to the system from any location. In effect, you can call the system as if it were an ISP. Once connected, a version of the program is visible to the user on their remote desktop. It contains exactly the same features, and operates as though the user was sitting in front of the system itself. Since the system is so fully flexible, it is possible to completely set-up or reconfigure the system from afar. The only thing that the user cannot change is the actual placement of devices and sensors. The logical setup that defines how the system will operate could be completely redesigned from a remote location. Also, the system is capable of contacting an operator via a voice phone call, email, or page alert. We intend to provide support for PDA devices as well. An interesting thing to note is that this system does not require any “real” devices at all. For example, if a system were installed at a site where all the work is done by hand, a “virtual device” can be used when a condition needs to be changed. An audio alarm can be sounded when a sensor or timer reports that an action is required. At that point, a human worker can do what is necessary to adjust whatever parameter is needed to remedy the situation. This could be immensely helpful in underdeveloped countries, and other locations where it makes more sense to have a human do the work than a device.

With accurate decision-making, condition recording ability, and remote control features the most important effect of the system will be better management of time, energy, and resources human as well as material). Workers will be free to do more complex managerial tasks and spend more time tending to their product. Instead of depositing too little or too much resources into an operation, which can be detrimental to crop health and is wasteful, exactly the right amount of material resources will be used in the operation. This will cut costs, and increase productivity. Hopefully, this will enable more agricultural operators to successfully implement complicated techniques beneficial to the environment, and the operation's economic outlook. Many complicated techniques can also be beneficial to the environment since the computer can decide when environmentally sound alternatives are appropriate, and also when to control resources and energy.

### How to Use the System

The system relies on a combination of hardware and software. On the hardware side, a user requires the following: a computer with memory and a means of storage, a monitor, keyboard and mouse. One or several analog to digital cards as in the case of the current prototype, or in the case of the derivative prototype, built in analog to digital chips and TTL level output lines. Relays, which switch a higher voltage load that powers a device, depending on the state of the TTL output lines. Sensors, which output an electrical response in relation to conditions sensed. On the software side, the code package will need to run on an operating system, or several operating systems (MS windows, DOS, Linux, Real Time Linux). In addition, a modem is required for remote access by telephone, and a network card is required for access over a network (Internet support will be developed as well). Serial communications between the derivative prototype and the base unit (which is a standard desktop PC), will occur with hardware that comes standard with most computers but extra hardware can send a RS232 signal very long distances by a variety of means including fiber optics.

Once the proper hardware and software is installed, the software must be started and configured. Using the greenhouse as an example to define how features work show how it has been used to grow mushrooms, and hydroponics plants, or how it could be used in any controlled environment.

### A. Configuring the A/D Cards

In the current prototype, the user has the choice of using several analog to digital cards, which have a certain number of Analog Inputs, and Digital Outputs. Each analog input can be attached to a sensor, and so for every input on the card, the software adds one object of type Sensor to the configuration. Each digital output can be attached to one relay that powers a device or set of devices, and so for every digital output on the card the software adds one object of type Device to the configuration. Depending on the type of A/D card, the software uses the proper driver to access those resources.

### B. Defining the Devices

Each device object contains a number of attributes. A unique name must be entered for each device. By using the Manual Override feature which sets the current state of the device, the user can select whether the device should be ON or OFF in its default state. This happens by overriding it ON or OFF, and then disabling manual override mode to allow changes to occur in the future. Later the program will set the device state to whatever it was when the program was last running and the configuration was saved. Finally, the user will determine how the device will handle any messages is receives from a variable number of sensors or timers that can be “linked” to it. It can behave in one of two ways. It will either turn itself ON when ALL messages request ON, or when ANY message tells it to turn ON. Similarly, it will turn itself OFF when ALL messages request OFF, or when ANY message tells it to turn OFF. This feature is necessary to accomplish complex behavior. For example, if the user would like a device to turn ON or OFF at the request of a sensor, but would like the ON behavior to occur in timed bursts, the user would “link” the device to both the sensor and a timer that might turn ON and OFF every 5 minutes. The user would specify that the device would turn ON only when both messages were ON, and that it would turn OFF when any message signaled that it should turn OFF. This can be a good strategy for controlling the humidity in a mushroom greyhouse for certain varieties of mushrooms.

### C. Defining the Sensors

Each Sensor object contains a number of attributes as well. A unique name must be entered for each sensor. The sensor type must be entered. The operator has the choice of using one of several pre-programmed types of sensors, or it can be of type “EQUATION”. The “EQUATION” type of sensor allows the operator to specify a mathematical equation that must include the variable “MV” which returns the number of millivolts that the sensor is reporting back to the A/D converter on its channel. It can also use the value of any other sensor in its equation (equations will be described in more detail under virtual sensors). The name of the units, which the condition the sensor is reading is described in, must be entered. For example, a temperature sensor would most likely have units of type “Degrees Fahrenheit”. A color should be picked using a standard color selector dialog box, so that the graph of the sensor readings can be easily distinguished from other readings in the graphical user interface. If a fixed set point is desired for that sensor, the “maintain value” should be set to whatever that sensor is trying to maintain in its own units. In more complex functionality (such as when the sensor is “linked to the calendar”), the maintain value can be automatically adjusted by the code every fifteen seconds. For example, if the program is playing back a recording, or if it is playing back a sequence of values drawn by hand in the graphical user interface, the maintain value will change over time. These are all different ways of being able to control a parameter like relative humidity or “RH” (where, for some mushrooms, blasts of dry air would help control mold populations; therefore, a hand drawn manual value would be more desirable). Finally, the “check period” must be determined for the sensor. This value is a time, specified in seconds, where the sensor is periodically checked to see if it needs to send any messages to linked devices. If the current reading of the sensor differs from the maintain value (plus or minus a “tolerance” value), the system will look at any linked devices to see if any device or devices exist that should have the proper effect on the reading (polarity). This behavior will be discussed in more detail in the Links section.

### D. Defining the Virtual Sensors

If the user desires, new sensor objects can be added from the Virtual Sensors Dialog Box. There are three types of Virtual Sensors.

A “Standard” Virtual Sensor, is simply a sensor object that does not have an actual physical analog to digital channel associated with it. Once it is defined, it can be accessed from the Sensors Dialog Box, and its behavior is identical to an ordinary sensor except its type is always “EQUATION”, and it's equation cannot contain “MV” (millivolts) because it does not have an electrical reading associated with it. In some cases, it is easier for the operator to create Standard Virtual Sensors than to make extremely complicated regular sensors. For example, a virtual sensor might be a variation on another sensor (call it greenhouse_temp_fahrenheit) which reads in units “Degrees Fahrenheit”. Using the equation window, the new sensor could be called “greenhouse_temp_celsius”, and its equation could be “((greenhouse_temp_fahrenheit)−32)/1.8)”. Most standard math operators are supported through the equation parsing process, and complicated, object oriented, nested, hierarchical, virtual sensor readings can be accomplished through this means.

Another good example of a standard virtual sensor is a humidity sensor we designed that uses a method called psychrometry. Psychrometry involves determining the air temperature of a dry “bulb” and, also determining the temperature of another “wet bulb”, which is a sensor that has a wick system that draws water to the surface of the sensor, and a fan that blows on it continually. The rate at which water evaporates off that bulb changes in relation to the relative humidity in the environment. Subsequently, the temperature of the “wet bulb” will be lower than the “dry bulb” if the humidity is lower than 100% in the environment, and water is evaporating. We designed a unique piece of code that accomplishes the mathematics to determine relative humidity from such wet and dry readings. For simplicity's sake, we defined a new operator in our parsing code, so that if we have two sensors, “wet_bulb” and “dry_bulb”, a standard virtual sensor with the equation “wet_bulb@dry_bulb” will return the relative humidity via psychrometry. So we use the virtual sensor called “greenhouse_RH” to control our misting devices in the greenhouse.

A “Simple Timer” Virtual Sensor, is a sensor that does not use an equation or return a reading, and does not have an analog channel associated with it. It will send an ON or and OFF message depending on what the “on time” and “off time” are, measured in seconds. It can be linked to a device or virtual device, functioning as a stand-alone timer, or linked in conjunction with other sensors.

A “Trigger Based Timer” Virtual Sensor, is also a sensor that does not have an equation that returns a reading, and it also does not have an analog channel associated with it. It has a default state, either ON or OFF, and when it is triggered, it will send the opposite message than the default message for a given time, which is measured in seconds. An equation is used to determine when the timer is triggered. An example of an equation based trigger timer would be “((TIME_MIN % 20)=4) & ((TIME_HR>7)&(TIME_HR<21))” which would trigger the timer if the time in minutes is divisible by 20 with a remainder of four (using the modulus operator), and it is between 8 AM and 8 PM. If the duration were set to 5 minutes, the timer would send an ON message for 5 minutes at 4, 24, and 44 minutes past the hour between the hours of 8 AM and 8 PM. This equation may use sensor readings in it's logic, and also variables.

### E. Defining Virtual Devices

Virtual Devices are device objects that are not related to a digital output or physical device. There are several types of virtual devices, which are all alarms. They may be linked to Sensors or Virtual Sensors, and the action they take depends on their type. An Alarm type Virtual Device will sound an audio alarm, which the operator can select. A standard Microsoft Windows WAV file may be specified in the path field, so the operator can record any audio they wish to be generated. Also, the time in between which the sound will be played may be specified in seconds. A Network Alarm type Virtual Device will play any one of a list of sound files, which is placed in a certain directory on all machines connected to the network. Any other versions of the software that are remotely linked to the system by network will sound the alarm simultaneously, to alert the operator from afar. Otherwise, a Network Alarm functions in the same way as a normal Alarm type Virtual Device. Other types of Virtual Devices include Email type, which will alert a user via an email on the internet, Pager type which will alert a user by sending a page, and also a Phone message type alarm which will dial a telephone number and play a WAV file a certain number of times.

### F. Linking Sensors to Devices

From the Sensors Definition Dialog box, the operator can choose to link the selected sensor to any available number of Devices or Virtual Devices. For each relationship, several attributes must be defined. Plus and Minus Tolerances define the sensitivity of the relationship. If the reading of the sensor is above or below the Maintain Value, a message will be sent to any device that will have the desired effect on the reading. The Plus Tolerance value is the range from the desired Maintain Value which is acceptable, and when the value is between the Maintain Value and the Maintain Value plus the Plus Tolerance, no action will be made. The Minus Tolerance value is similar, defining the acceptable range below the Maintain Value at a certain time which is acceptable deviation from the desired condition.

In order to determine which devices to use at which time to remedy a certain condition, the Polarity of a link relationship must be defined. If a Positive polarity is selected, the device will increase the reading of the sensor. If a Negative Polarity is selected, the device will decrease the reading of the sensor. For our greenhouse example, a heater device will have a positive polarity in relation to the greenhouse temperature, and an evaporative cooler or air conditioner would have a negative polarity in relation to the greenhouse temperature. Sometimes, a device will have a varying effect on the sensor reading. For example, an air intake fan may cool the greenhouse off, only if the outside temperature is lower than the greenhouse temperature. For situations like this, a dynamic, Equation Based polarity feature has been included. If a Dynamic Equation Based Polarity relationship is specified, the operator may choose via a radio button that the polarity will be either Positive or Negative based on the given equation, if the equation returns true. For our example, the air intake fan will have a Positive polarity in relation to greenhouse air temperature if the equation that follows is satisfied. “outside_temp>greenhouse_temp”. Otherwise, the polarity will be Negative.

### G. Linking a Sensor to the Calendar

If the operator would like the Maintain Value of a sensor to change over time, they should link the sensor to the calendar from Sensor Record/Play dialog box. Once this is done, the editing features of the graphical user interface are enabled. On the graph which represents the current day that is selected through a calendar control object, the operator must use the pencil, or line tool to draw the maintain value settings which they would like for that sensor. Every pixel on the graph (in the X coordinate) represents a fifteen second period of time. For example, by using the line tool to draw a line from the beginning of the graph, at 12 midnight, to the end of the day, the user could generate a ramp of desired temperature spans across the whole day. The line tool may also be used to draw lines from any time in X space to any other spot. The Pencil tool can be used to draw curved or other irregular patterns of Maintain Value settings. With the Cut, Copy, and Paste feature, the operator can easily fill in the calendar with the appropriate settings. With the Log Loader Dialog Box, the operator can browse the computer for log files that were either recorded, or generated with the GUI, and load them in to the programs bank of log files. The Generator feature of the dialog box allows the operator to load a log file or series of log files from disk, and automatically insert them into the calendar at the selected date in the calendar control. These “template” log files will be inserted into the calendar at the date selected, but first, the readings are passed through an equation filter (a unique equation for each file in the “play list”) which allows the operator to make variations on the original template files. For example, if seven log files (for controlling relative humidity in a greenhouse, for example) are loaded into the “play list”, they will be sequentially be filled into the seven days following the date selected on the calendar control. Afterwards the calendar control will be updated to point to the day seven days past the day previously selected. There is also a field that will allow the user to fill in the sequence X number of times in a row. Each time it is generated, the equation window will be used to modify the template file in a certain way. In our seven-day example, we might use the same log file as the template, but each time, we will specify a different equation for that day. The equations could read as follows. TEMPLATE, TEMPLATE+5, TEMPLATE+10, TEMPLATE+15, TEMPLATE+20, TEMPLATE+25, TEMPLATE+30. Each day, the template value at each fifteen second spot would be adjusted appropriately. If we specified that we were to repeat the play list 4 times in a row, we would generate the week long sequence which ramps the values up, 4 times in a row, to fill in the month.

### F. Other Notes

Other features include the Autosave feature. The operator can specify how often the program will save its current recordings, and in which directory. A “Mirror” directory path may also be specified, so that the program can save its files on another computer. At our greenhouse operation, we had two computers running our three greenhouses. Both computers were connected by network to our Server machine, and their mirror directories were located on it. This way, when we dialed up the Server machine, we could access the mirror directories, change the settings of each computer, and not worry about interrupting their operation while we connected and disconnected to the server, which often causes computers to hang up. Also, we could distribute our processing, and most easily determine if we had some kind of problem on either controller computer.

A variables dialog box can also be included in the desired functionality. This will allow the user to define variables, which have an initialization, and increment routine. By means of the variables dialog box, the user can keep track of factors that are not already tracked. Heat Units and other variables can already be tracked as virtual sensors, but variables will provide a more efficient and flexible method.

### G. Code Development Outline

The method of system of the present invention was first realized by the following software program code, although the claims are not limited to such an embodiment. The program was developed under the Microsoft Windows 9x operating system, using Microsoft Developers Studio, Visual C++. Some drivers for Analog to Digital Cards were installed from their vendors, and other drivers were written by the inventors for some of the cards. The software was written using object oriented programming techniques. Standard Microsoft Windows objects were included in the project, and it relies on standard modeless dialog boxes and frame classes to display and collect information to and from the user. As much as possible, the core functionality of the program was maintained separate from the windows platform. Only data display and entry are handled through windows, the actions and timing routines are platform independent, requiring only a call to the system time which happens every 500 milliseconds. A file system is used for remote monitoring and reconfiguration of the program. Changes to settings are accomplished through this file, allowing remote communication across a variety of networks or telephone lines, downloading and or changing only an ascil text file as the means of communicating changes and state. Internally, the components of the software are designed in an object oriented, heierarchical, encapsulated way. The “Genie” object performs all the control procedures. It checks the system time, and looks at the sensor and device objects, and performs any actions as well as handling the file system. The Sensor objects exist in a static array, and they contain “play” and “record” log files, as well as a list of linked devices, and other attributes. The Device objects also exist in a static array, and they contain “record” logs of their behavior, as well as a list of linked sensors, and several other attributes. The main program can load and save files of type “readout (.RED)”, which include all the important members and settings available in the program. Any change in settings that can be made from the program is saved in the .RED file of the user's choosing. Upon startup, the program can be configured to automatically start up with a certain .RED file.

### DETAILED DESCRIPTION OF THE FIGURES

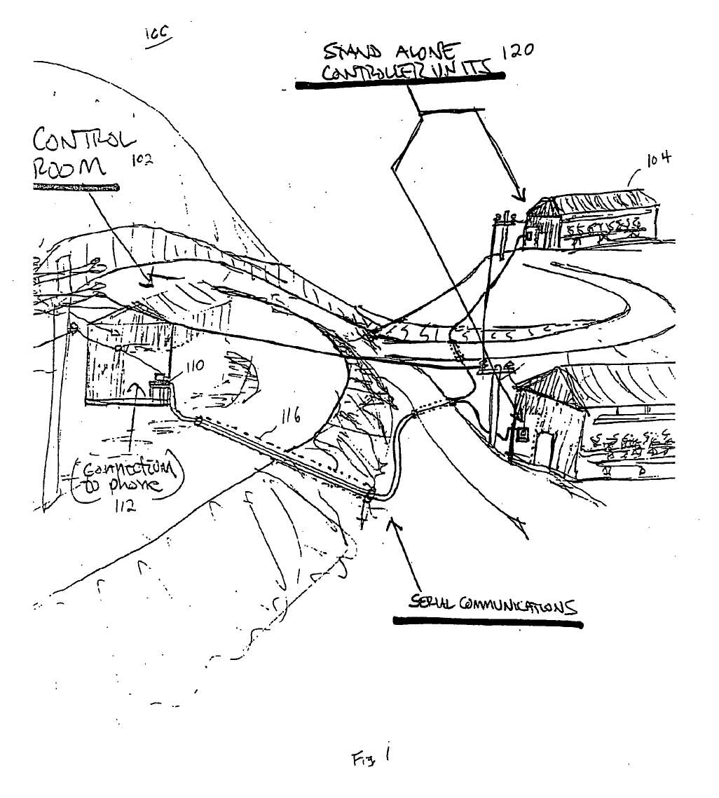

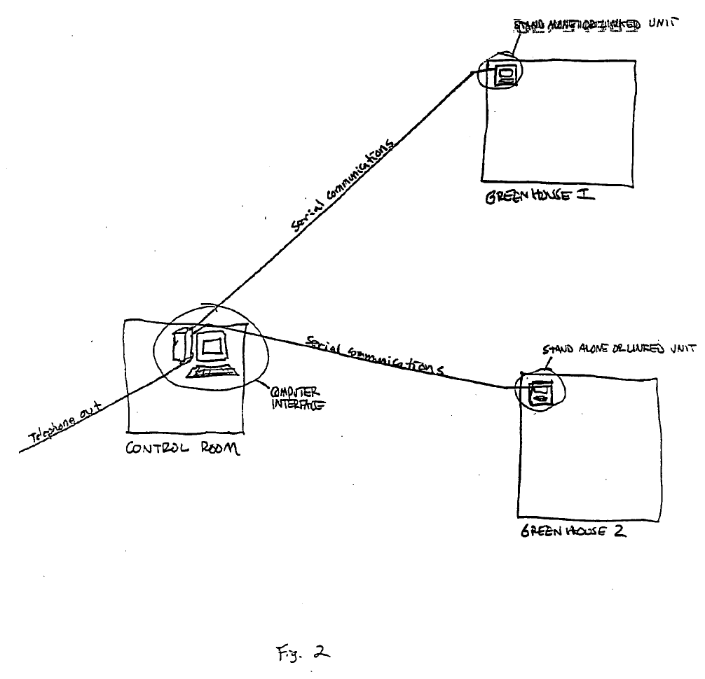

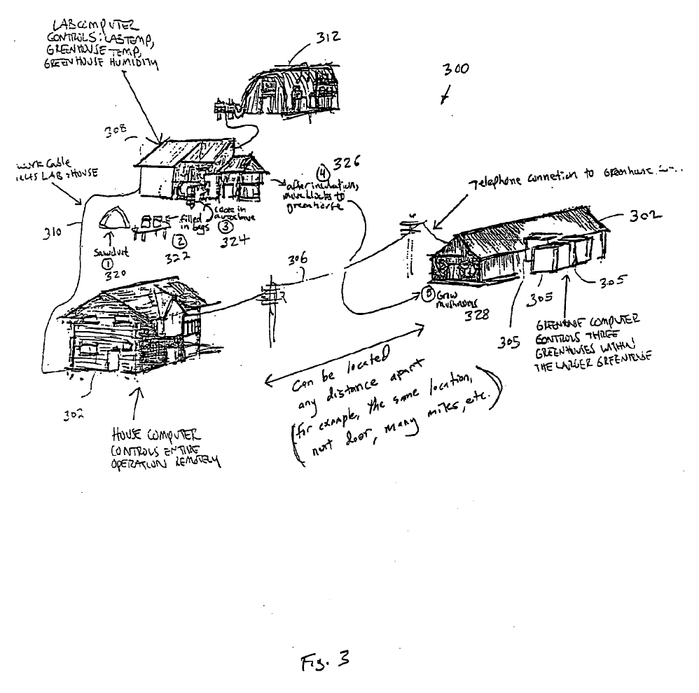

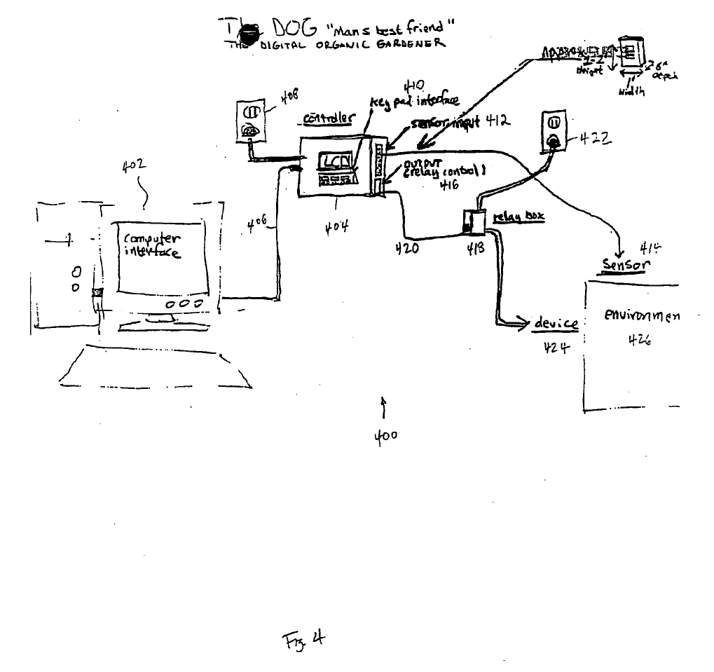

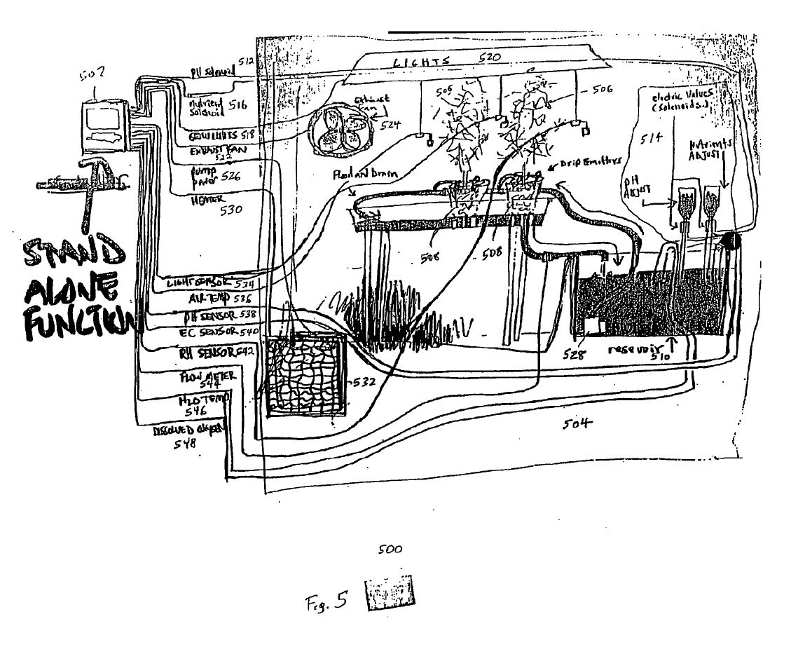

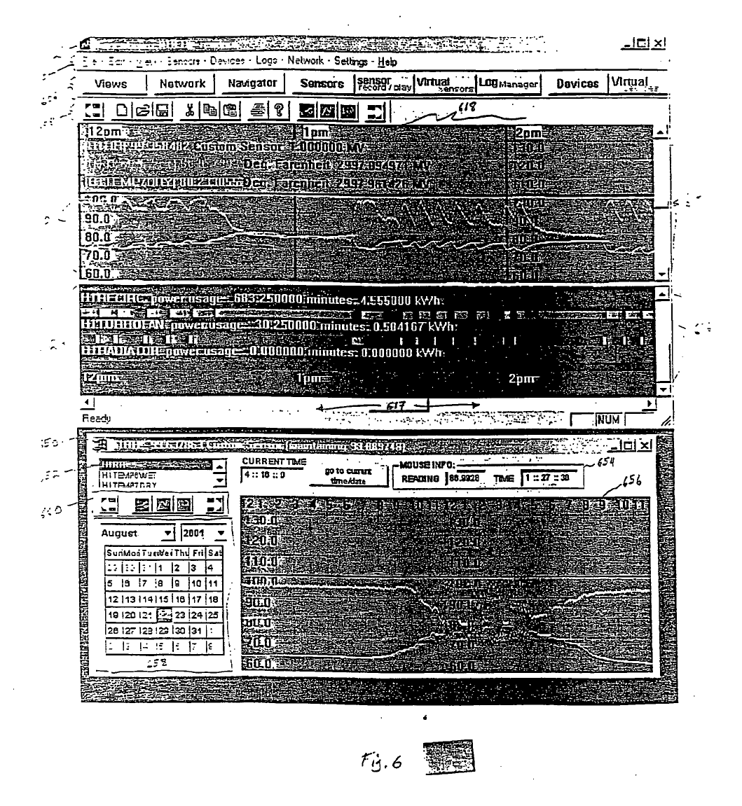

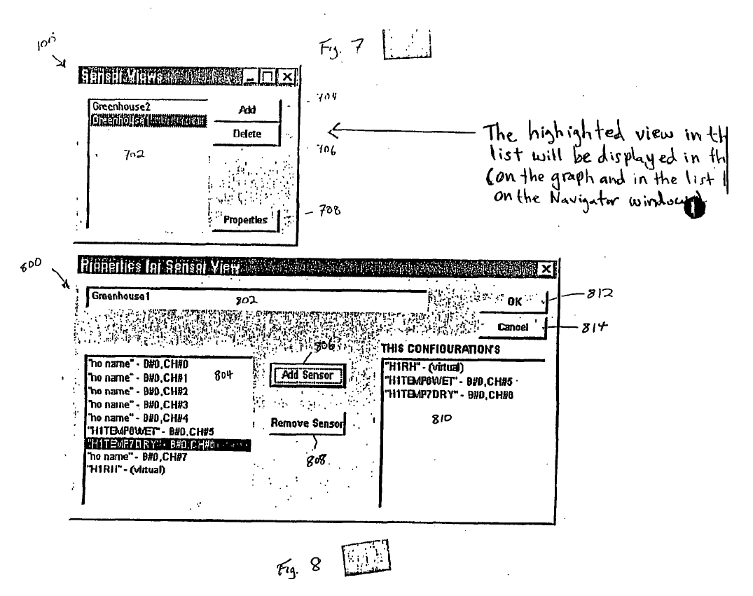

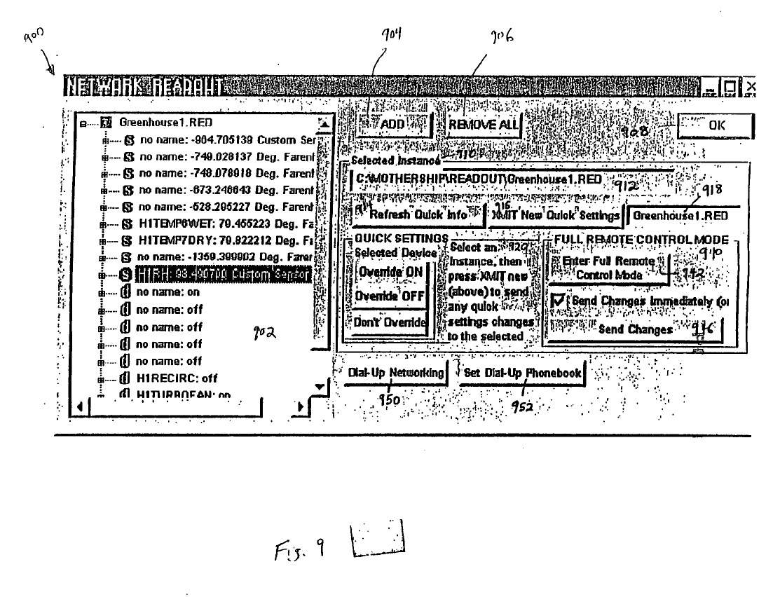

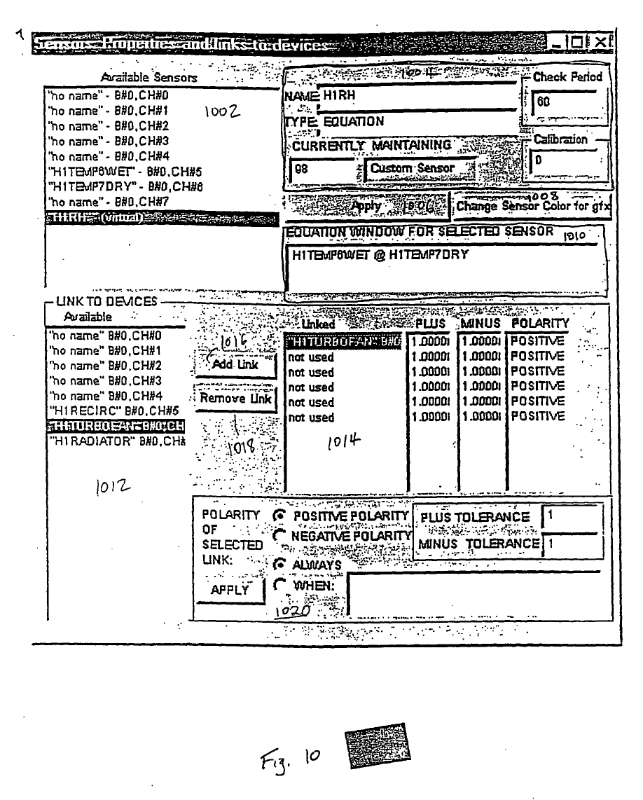

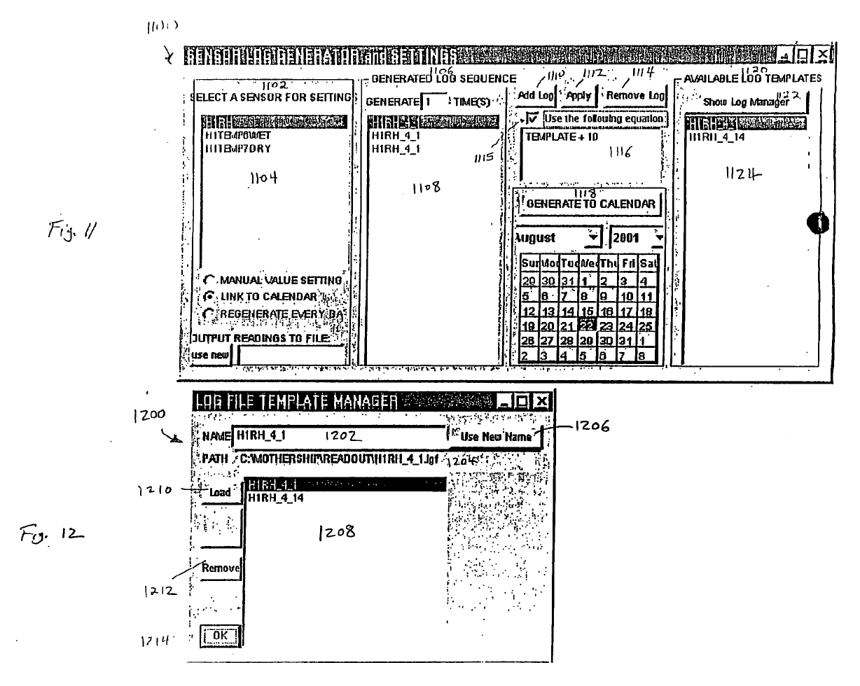

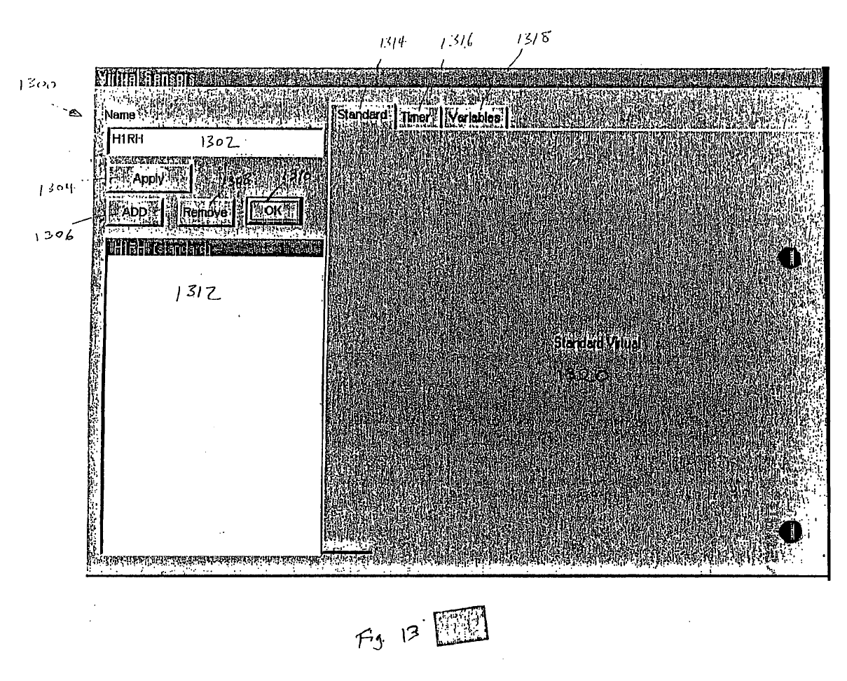

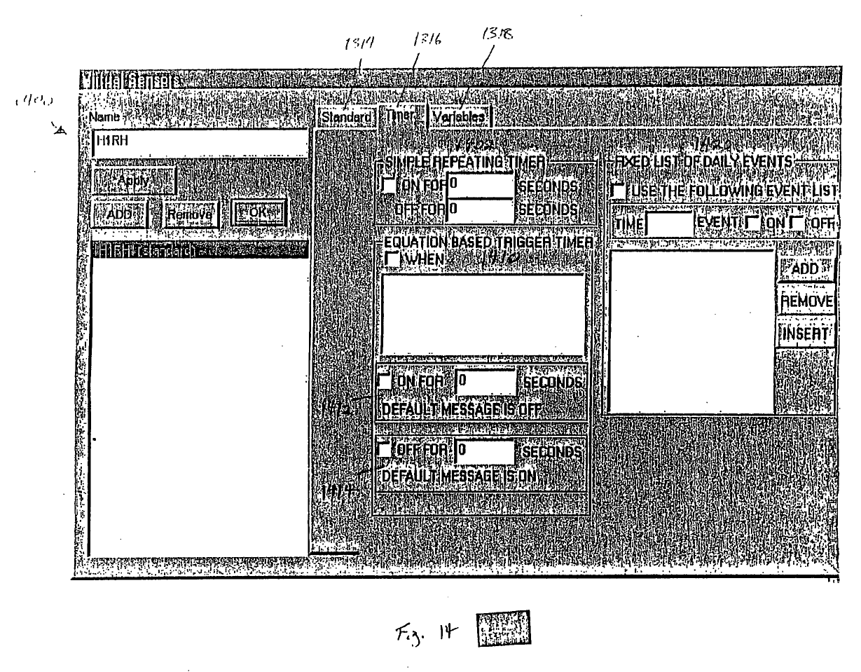

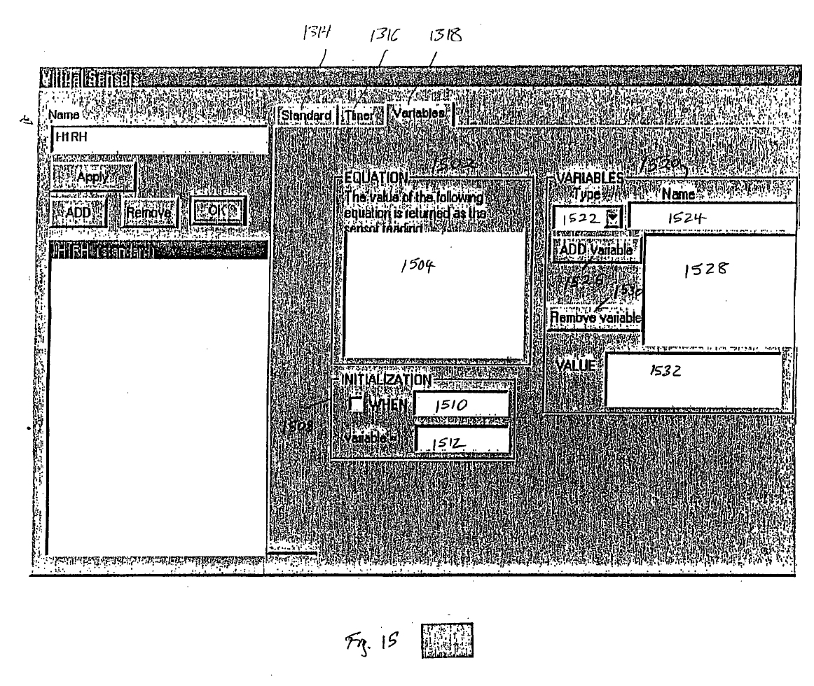

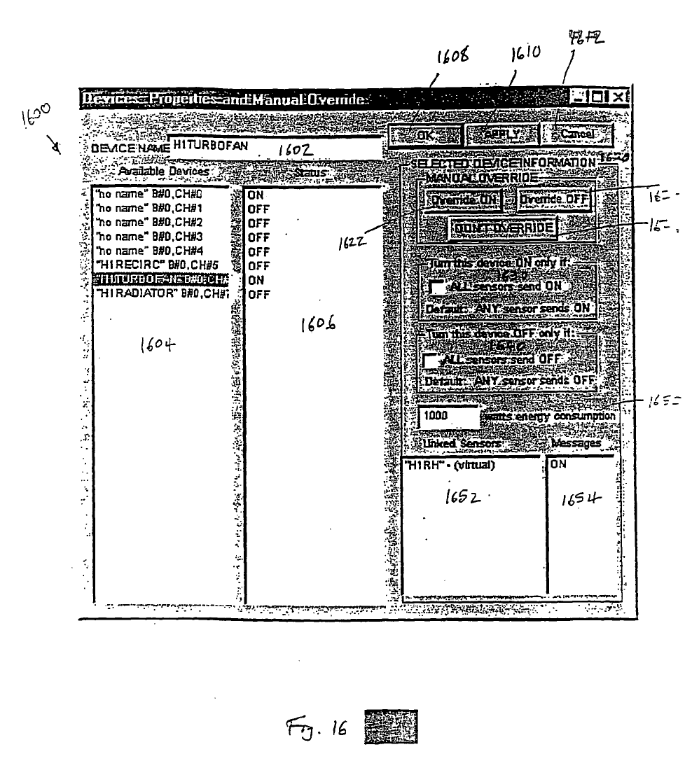

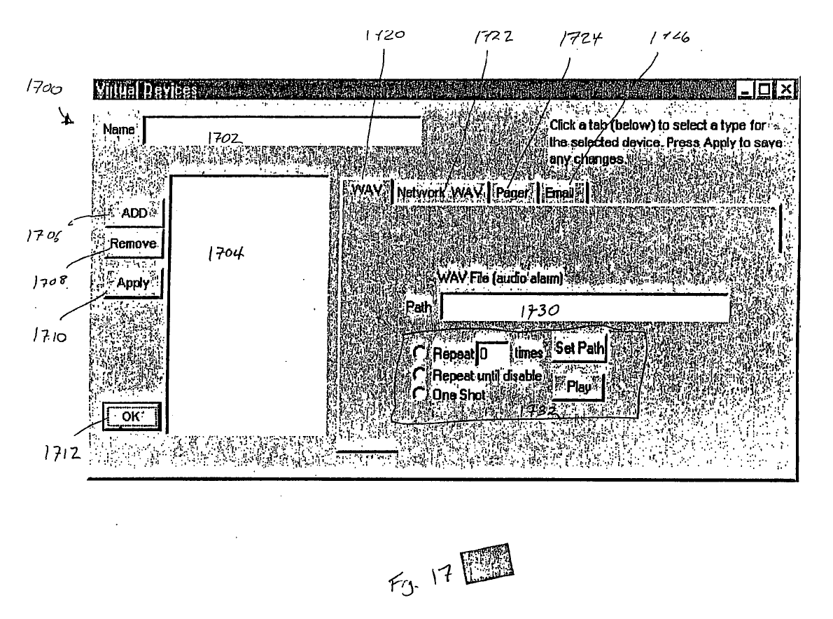

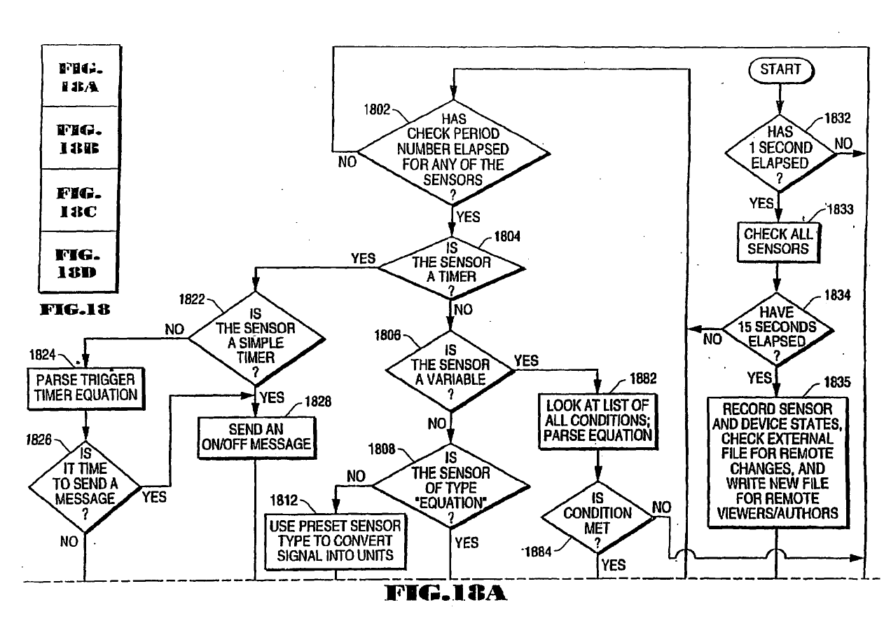

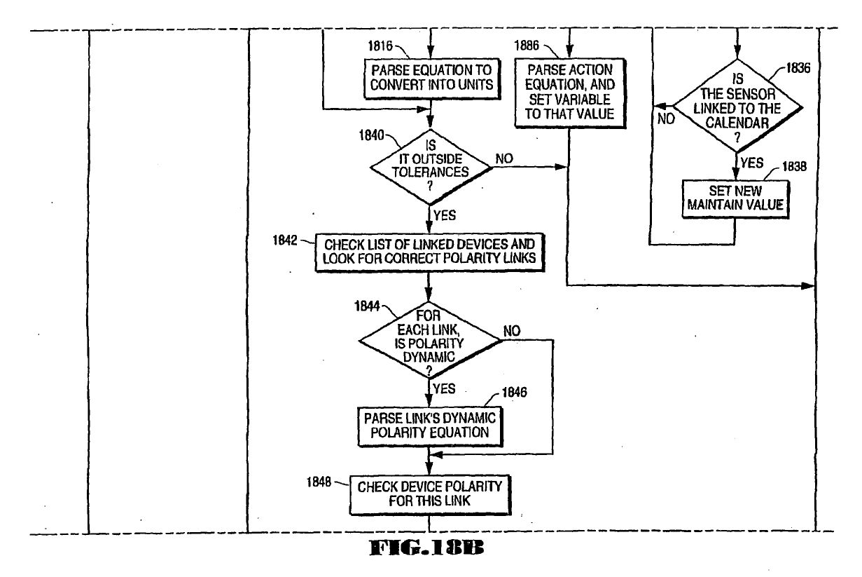

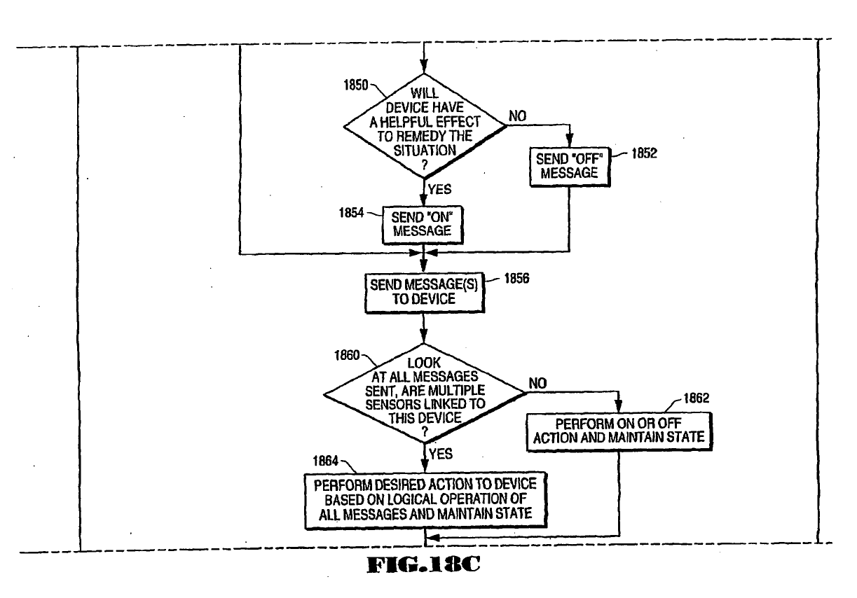

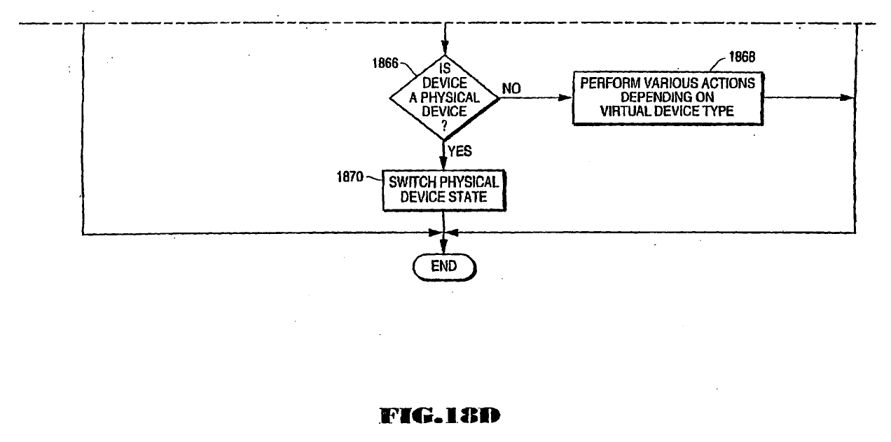

FIG. 1 illustrates one exemplary environmental control system 100, according to one embodiment of the present invention. The stand alone or linked controller units 120, located within two greenhouses 104, may function separately, or may be linked by serial (or parallel, or other) communications 116 to a computing terminal 110 located in the control room 102. Additionally, the remote control features extend to a telephone line output 112 from the computing terminal 110, which may connect via telephone connection 114 to any number of remote terminals; by way of this connection, alarms can be sent via internet, RAS connection, and/or any tele- or other-communication media (with such alarms taking the form of pages, phone calls, recorded voice messages, etc.).

FIG. 2 is a block diagram illustrating various components and connectivity of the environmental control system 100 (network system) of FIG. 1.

FIG. 3 is a representation of the beta operation system and methodology 300 used by the inventors to develop and test the invention. In this embodiment, sawdust 320 is mixed with water, grain, gypsum, bran, and then filled into autoclavable plastic bags 322. The bags of substrate are then sterilized in the autoclave 324. The invention is used to control and monitor the cooking process (using a computer within lab 308). The autoclave has one door outside, and one door inside a laboratory where the mushroom cultures are grown and maintained. After cooking, the sterile bags of substrate are removed from the autoclave on the inside of the lab, and are then innoculated with mushroom mycelium. The air temperature of the lab is controlled by the control system of the present invention (via computer in lab 308). Once the bags are innoculated and have sufficiently grown full of mycelium, they are transferred to the test greenhouse 312, or to the main greenhouse 304. The lab computer controls the operation of the test greenhouse as well as the laboratory and pressure cooker functions. The final step of the process is the growing of mushrooms 326. The bags are removed from the mushroom blocks, and they are placed in any of three smaller greenhouses 305 located within the larger greenhouse. The greenhouse computer controls the environments in the three greenhouses. It is connected by telephone line 306 to a house computer located in house 302, which controls the entire operation remotely. The house computer is also connected by a network cable 310 to the lab computer in lab 308.

FIG. 4 illustrates a computer and sensor system 400, according to one embodiment of the invention. In this embodiment, the stand alone or linked main unit 404 is the base unit of the system 400. It may be optionally connected by a serial (or parallel) communication line 406 to a desktop computer 402 that can act as an interface. The main unit 404 can be powered by a standard 120V 60 Hz power outlet connection 408. Externally, the main unit 404 shows a liquid crystal display, a keyboard, and a keypad, allowing an operator to view and edit information through such user interface 410. Also it has connections for sensor input 412, and connections for device outputs 416. A sensor 414 connected to the main unit 404 is shown to demonstrate such connection. Also, an exemplary device output line 420 is illustrated. The device output line 420 connects to a relay box 418, which uses the device output current to switch a higher load (such as exemplary device 424) using current from a wall outlet 422. This higher voltage current powers the exemplary device 424. The sensor 414 and device 424 provide information and adjust conditions, respectively, to monitor and control a given environment 426.

An exemplary greenhouse system 500, showing a stand alone function, is illustrated in FIG. 5, according to a preferred embodiment of the present invention. A hydroponic garden 504 is illustrated which is controlled and monitored by a stand-alone or linked unit 502, operating in stand alone mode. A reservoir of water nutrient solution 510 recirculates water through the system alternately to feed and water the crop 506. The crop is planted in containers of porous rock 508, over which the water nutrient solution flows alternately.

Information is provided to the system by a set of sensors. A light sensor 534 determines the intensity of light, and determines if the lights 520 are functioning correctly. An air temperature sensor 536 determines the ambient temperature of the environment, and may also help determine if the heater 532 is functioning correctly. The Ph of the water nutrient solution is determined by a Ph sensor 538, and may indicate if the Ph adjustment mechanisms 514 (solenoids) are working and able to deliver Ph adjustment solutions. The electrical conductivity of the water nutrient solution is determined by an electrical conductivity sensor 540. The electrical conductivity sensor 540 provides information on the amount of nutrients in the solution, as well as several other factors like water temperature. It may also help determine if the nutrient adjustment mechanism 514 is working and able to deliver nutrient adjustment solution. The relative humidity of the air is determined by the relative humidity sensor 542. The rate that water is flowing through the system, and correct pump operation is determined by the flow meter 544. The water temperature is also determined by a water temperature sensor 546. The dissolved oxygen level of the water nutrient solution is determined by a dissolved oxygen sensor 548.

Devices used to adjust conditions in the environment are controlled by device outputs, and relays located along the connection to the devices (not shown). A Ph soleniod connection line 512 is used to switch a Ph adjustment mechanisms 514. Several of these connections may be needed to maintain proper Ph balance in the water nutrient solution. When the nutrient level is too low (as determined by the electrical conductivity sensor 540), power is supplied along the nutrient solenoid connection line 516, and powers the nutrient adjustment mechanisms 514. The grow light connection line 518 will provide power to the lights 520 when they should be turned on. The exhaust fan connection line 522 will power the exhaust fan 524 for ventilation cycles, or potentially to lower or raise the air temperature. The pump power connection line 526 will power the pump 528 when the water nutrient solution should be delivered to the plants. The heater connection line 530 will power the heater 532 when the air temperature needs to be higher, or possibly when the humidity is too high and heat levels are tolerably high.

### Navigator Window and the Main Frame of the GUI

With the program GUI 600, the main frame window 602 is a split view of sensor information 610 and device information 612 areas, according to an embodiment of the present invention illustrated in FIG. 6. The program GUI 600 can also include a menu bar 604 (having, for example, pull-down menu options such as “File,” “Edit,” “View,” “Sensors,” “Devices,” “Logs,” “Network,” “Setting” and “Help”), an options toolbar 606 (having, for example, buttons allowing such selections as “Views,” “Network,” “Navigator,” “Sensors” (see FIG. 7), “Sensor: record/play,” “Virtual Sensors,” “Log Manager,” “Devices” and “Virtual Devices”) and/or an editing-type toolbar 608 (having, for example, buttons for go-back (in time, with respect to the time indicated at the top of the sensor information area 610), new, open, save, cut, copy, paste, print, help, draw, line, zoom and go-forward, according to this illustrated embodiment of the present invention. Most of the selections or options that differ from established functionality (of, for example, the Windows operating system) are described in more detail below. Other options having functionality beyond just such established methodology are inherent to the disclosure set forth herein. A user can utilize the scroll bars 614, 616, 617 to move to areas of interest in either the sensor information area 610 or the device information area 612. The sensor information area 610 shows units, such as magnitude of sensor reading and time of day in respective columns (seen in the upper data field 618), and sensor graph within a main frame graph field 620, as well as text information (also in the upper data field 618) about all of the sensors in the currently selected sensor view. The device information area 612 shows specific state and numerical data concerning the various devices under consideration, and the indicated data can be keyed to an appropriate timeline. The device information area 612, as shown here, can use the same time of day columnar information from the sensor information area 610; as seen in the embodiment of FIG. 6, every pixel in the X (horizontal) dimension can represent 15 seconds or any other interval of time. In the preferred embodiment, one horizontal scroll bar 617 is linked to both the sensor information 610 and device information 612 areas, so that the sensor information and correlating device information will be viewed exactly in relation to each other. Information concerning the various devices, such as ON/OFF status, can be shown by any suitable indicia within the device information area 612; for example, a red bar might indicate that a device was on during that time period, with a black bar indicating that the device was off during that time.

The navigator window 650 is pictured immediately below the main frame window 602 of the program GUI 600, and can be repositioned or minimized into any desirable viewing state. The list box 652 in the upper left corner of the navigator window 650 displays the sensors contained in the sensor view 610 that is currently selected from the sensor views dialog box (see FIG. 7). Selecting a sensor in this list from the navigator window 650 will highlight the associated sensor graph within the sensor graph field 620, and allow the user to use the cut, copy, paste, draw and other tools in relation to that sensors information on the graph. Inside a mouse info frame 654, the user can see exactly what reading and time is underneath the cursor. The user may use the tools, or view information by positioning the cursor over any spot on the graph, either in the sensor information area 610 of the program GUI 600, or on the navigator window graph 656 (shown here displaying a full day view). The user can use the calendar control 658, located on the bottom left side of the navigator window, if they want to view the readings from a particular day. The user can then select from various tool actions within a group of edit buttons 660 if they wish to draw, cut, copy, paste or perform other actions to ‘maintain value’ information to any date in the future. By double clicking on a date, the program will retrieve information from that date to be viewed on the program GUI 600 (in the sensor information area 610 and/or the navigator window 650), and any tool actions will apply to that day. Also, the user may use the arrow left and arrow right buttons (from the edit buttons 660) to move backwards and forwards in time, respectively.

In the preferred embodiment shown in FIG. 6, a user can select a region of information by first holding down the left mouse button and moving the mouse cursor horizontally. Then, the user can choose to cut, copy, or paste that information (from a play log, not the recording log), on to any other day in the future or the current day, or copy any information from the past or the future. By selecting the draw tool (indicated in FIG. 6 by a button having the icon of a pencil on it), the user can hold down the right mouse button to draw on either the graph in the main frame window 602, or the navigator window 650, and specify graphically what they would like the maintain value (set-point) to be at a given time. Every pixel in the sensor information area 610 represents 15 seconds, and a linear approximation is used if the user draws on the navigator window 650. The user can access the line tool by pressing the line tool button, which shows linear maintain value settings, or by selection from a pull-down menu. By holding down the right mouse button during use of the line tool, the user can specify the beginning and end points of a line that will represent a ramp in maintain value settings for the selected sensor. The user can access the zoom tool by pressing the button depicting a magnifying glass: by positioning the cursor over a point of interest, and holding down the right mouse button, and moving the mouse up, the graph will zoom in, by moving the mouse down, the graph will zoom out. In a preferred embodiment, the zoom behavior affects only the Y-axis of the graph. The zoom tool can be used to center the readings of any type of sensor on the GUI, so that they may be best comprehended and compared to the device states. The navigator window graph field 656 and the main frame graph field 620 will both zoom simultaneously, to maintain proper perspective.

### Sensor Views

As seen in FIG. 7, the Sensor Views window 700 is used to display, define and select from various groups of sensors that the user would like to simultaneously view on the program GUI 600, according to a preferred embodiment of the present invention. Viewing all sensors (i.e., from one greenhouse) at once can be confusing; by defining smaller groups of sensors, it is easier to comprehend information, and the relationships between the sensors at one time. Often, these groups may illustrate the happenings in separate environments. For example, in a preferred embodiment, different sensor views could be defined for different greenhouses (such as Greenhouse1 and Greenhouse2, shown in FIG. 7). Whichever Sensor View is selected in the Sensor Views box 702 will be the Sensor View displayed on the program GUI 600, and that list of sensors will be displayed in the Navigator Window 650, as well as in: (1) the text and graph of the sensor information area 610 (also called the Play List window), (2) the list box 652, and (3) the list of specified sensors 1104. The user may create a new sensor view option in the sensor views box 702 by pressing the ADD button 704, and the user may delete the selected sensor view by pressing the delete button 706. The user may access the properties of the sensor view selected in the sensor views box 702 by pressing the properties button 708, which will display a window like that shown in FIG. 8 for the selected sensor view.

### Properties for Sensor Views

According to the embodiment illustrated in FIG. 8, the Properties for Sensor Views dialog box 800 can include a selected sensor view field 802, an available sensors field 804, an add sensor button 806, a remove sensor button 808, a selected sensor field 810, an OK button 812 and a cancel button 814. Each sensor view is a list of sensors, which can be displayed on the program GUI 600 in the order that the list is defined. The user may select a sensor from the list of all available sensors 804 located on the left side of the Properties for Sensor Views window 800, and press the ADD Sensor button 806 to add that sensor to the sensor view. A sensor may be removed from the sensor view list by selecting it in the selected sensor field 810, and pressing the remove sensor button 808. When the list of sensors within the selected sensor field 810 is in a satisfactory state, the user can press the OK button 812 to close the dialog box 800.

### Network Readout

The network readout dialog box 900 shown in FIG. 9 is designed to manage remote communications abilities, according to one or more embodiments of the present invention. The network readout dialog box 900 can include an instances window 902, a selected instances action field 910, an add button 904, a remove all button 906, a dial-up networking button 950, a set dial-up phonebook button 952, and an OK button 908 to accept any of the changes they might select from this dialog box. If the user is connected by telephone or a local access network to another computer that is running an instance of the program, they will open both a version of the program on their computer, and a network readout dialog box 900. If the computer they are working at happens to be running an instance of the program that is controlling an environment, they can also open the network readout dialog box 900 (where the first item is always the current instance), but they should not enter full remote control mode from that instance of the program. They should open another instance that is not controlling anything locally.

The instances window 902 can display a tree of information on any number of instances that the user has added to the list. By pressing the ADD button 904, an open file dialog box will appear, and the user should browse their network (LAN or Dial Up), and specify the .RED file of the instance they would like to monitor or control remotely. At that point, a new item will be added to the tree. By selecting the item, and clicking the “refresh quick info” button 914, a sub tree of information will be added to that item. The sub tree contains an item for each one of the sensors and devices defined in that file instance. Subsequent presses to the “refresh quick info” button 914 will refresh the data contained in the sub tree.

When a device data item in one of the sub trees is selected, the user may change the state of that device from their remote location, such as by choosing selections from within a quick settings field 920. They may choose to override the selected device ON or to override the selected device OFF, or even to turn the override mode off. Once the changes have been made, the user must press the “xmit new quick settings” button 916 to send the changes to the selected instance.

If the user wants to have more full control over the remote system of their choice, they need only select that item in the network tree, and press the “enter full remote control mode” button 942 within the full remote control field 940. At that point, the program will set up a relationship with that remote instance, so that the version of the program running at the local user's side will appear and behave exactly as if the user were sitting in front of the physical system they are communicating with. The only difference is that the user has the choice of transmitting all changes made on the remote side in one of two ways (which way is selected by the check box located in the network readout dialog box). Either the changes will be transmitted and verified exactly upon their specification by the user on the remote side, or the changes will be sent in batch, when the user presses the “send changes” button 946. Often it will be more convenient to make many changes first, before sending them, since it takes a brief period of time to send the changes and confirm their receipt by the running system.

The Dial Up Networking button 950 will bring up the Dial Up Networking Dialog Box which accesses the RAS (remote automated server) functionality of the system, which can automatically dial a phone number and connect the remote computer to other systems on a remote LAN. The set dial-up phonebook button 952 provides a user with standard options for setting and selecting phone numbers to be dialed for the desired systems.

### Sensor Properties and Links to Devices Dialog Box

The sensors dialog box 1000 shown in FIG. 10 can be used to serve two purposes, according to a preferred embodiment of the present invention. First, it can allow the user to specify and change most of the settings of the sensors used in the system. Additionally, given that virtual sensors will appear in the sensor properties box 1002 when created in the virtual sensors dialog box (see FIGS. 13-15), the virtual sensors can be linked to devices so that their maintain value and check period can be specified, as well as such attributes as their color on the sensor view 610 graph. Moreover, if the virtual sensor is a standard virtual sensor (meaning that it is not associated with an electrical signal and/or channel), its functionality or equation can be established by means of the sensors dialog box 1002 (for example, timer types can link here).

When the user selects a sensor from the list of available sensors 1002, the rest of the sensors dialog box 1000 fills with information that describes and relates to the selected sensor. The name, type, calibration, and check period of the sensor can be entered into the edit boxes 1004 immediately to the right of the sensor list, as seen in FIG. 10. Also, the maintain value (sometimes called set-point) can be manually entered in one of the edit boxes 1004; in the preferred embodiment, manual entry can occur as long as the sensor is not linked to the calendar from the sensor log generator dialog box. If the sensor is linked to the calendar, the maintain value will be reset every 15 seconds by the program, according to the specified sequence specified in the “calendar”. This embodiment can also include an apply button 1006 and a change sensor color for graphics button 1008, as seen in FIG. 10. When the sensor is of type “EQUATION”, the information in an equation window 1010 (which the user may edit) will be parsed to tell the program how to interpret what the reading of the sensor is at any given time.

Every sensor can be linked to an infinite number of devices; in the preferred embodiment, however, the sensors tend to be linked to the neighborhood of 4-6 devices. To create a sensor link, the user need only select a device from the available devices list 1012, select the link in the “linked” list 1014, and press the “add link” button 1016. Similarly if the user would like to remove a link they need only select it in the “linked” list 1014, and press the remove link button 1018.

The polarity of the sensor to device link relationship must be defined using the radio buttons from the polarity selection field 1020 located below the “linked” list 1014, as seen in the embodiment illustrated in FIG. 10. Within the polarity selection field 1020, the tolerances can be specified by entering values in Plus Tolerance and Minus Tolerance boxes. When a fixed polarity is necessary, the positive or negative radio button should be selected, and the “always” radio button should be selected. A dynamic polarity is specified by selecting the “when” radio button and entering a logical equation that will be true when the polarity is either positive or negative depending on whether the user selects the positive or negative radio button above.

### Sensor Log Generator and Settings

The sensor log generator and settings dialog box 1100 allows the user to access the recording and playback features of the system, and to select whether a sensor has a fixed maintain value (set-point) or if it is linked to the calendar; an exemplary dialog box is illustrated in FIG. 11, according to one embodiment of the present invention. The select a sensor for setting field 1102 on the left side of FIG. 11 a list of specified sensors 1104 (from the currently viewed configuration) that are currently specified by the sensor views dialog box (see FIG. 7). Once a sensor is selected from the list of specified sensors 1104, the rest of the sensor log generator and settings dialog box 1100 will fill in with, and apply to, data relevant to the selected sensor. Directly below the list of specified sensors 1104 in the select a sensor for setting field 1102, the user can specify if they would like to link the sensor to the calendar, or if they would like a manual maintain value (set-point) setting. Also they have the option of using the log sequence to regenerate a play log file every day. (The equation used might vary that log file in a way that is somehow based on time elapsed, variable or other sensor data.) Directly below that, the user may specify a non-default filename to output readings or recordings to. The default name is the sensor name plus the month and date.

The center portion of the sensor log generator and settings dialog box 1100 is comprised of a generated log sequence field 1106 including a play list 1108, an “add log” button 1110, an “apply” button 1112, a “remove log” button 1114, a “use the following equation” check box 1115, an equation field 1116, and a calendar field 1118.

On the far right of the sensor log generator and settings dialog box 1100 is an available log templates field 1120 including a show log manager button 1122 and a list of all available log files 1124 that are loaded into memory with the log template manager. These files may be used as templates when generating a play list to the calendar. By selecting a log in the available log templates list 1124, and then pressing the “add log” button 1110, the log is added to the play list 1108 (generated log sequence). After the template(s) have been added to the play list 1108, the user can specify to remove an individual log by selecting it and pressing the “remove log” button 1114. Or, the user can check the “use following equation” check box 1115 so that the selected log file will be processed with the equation of their preference, as it is generated to the calendar. In the illustrated embodiment, the variable “TEMPLATE” in the equation field 1116 refers to the value in the template log file, at each time spot (every 15 seconds), as it appears in the template. Each file in the play list 1108 has it's own equation; if it is checked for that log, the system will follow that equation. Above the play list 1108, the user can specify how many times in a row they would like the list of logs to be generated to the calendar. When all this information is entered, the user should select a day to begin generating the information to the calendar by selecting a start date using the calendar controls in the calendar field 1118. When the desired date is selected, the user should press the “generate to calendar” button. At that point the calendar control will automatically advance itself however many days worth of information it has written to the calendar (such information being written to disk for use in the future).

### Log Template Manager

The Log File Template Manager dialog box 1200 is a means of loading log files into the program memory, as illustrated via the embodiment shown in FIG. 12. Once the log files are loaded, they remain in the current .RED file, and may be used with the Sensor Log Generator functionality. By pressing a “load” button 1210, the user will be shown a standard windows list box to open a file, with which the user can specify the file they would like to load into memory. When a log file or log files have been loaded, they will appear in the loaded log file list box 1208. Selecting a file in this list will allow the user to edit the name in the name field 1202 to give it more significance than whatever the recording name was, if so desired; the respective path information is displayed in the path field 1204. The user must press the “use new name” button 1206 after editing box 1202 to save changes to the name. Additionally, the user may remove the file from memory by selecting the file and pressing the “remove” button 1212. When the user has made the desired selections, he or she can then press the “OK” button 1214.

### Virtual Sensors

Users may decide to add virtual sensors to their list of sensors available in the Sensors Properties and link dialog box 1000 (FIG. 10), or in the properties for sensor view box 800 (FIG. 8), as mentioned above. In FIGS. 13-15, the functionality of such addition of virtual sensors can be realized by means of a virtual sensor dialog box, which can further display (via user tab control) a standard tab 1314, a timer tab 136 or a variables tab 1318 to allow user selection of the respective criteria related to the virtual sensor(s) in question. In addition to illustrating these three types, the virtual sensor dialog box displaying standard tab 1300 shown in FIG. 13 further includes a virtual sensor name field 1302, an “apply” button 1304, an “add” button 1306, a “remove” button 1308, an “OK” button 1310, and a virtual sensor list 1312, according to one embodiment of the present invention. During manipulation of virtual sensors, the user must press the “add” button 1306 to add a new virtual sensor. The user can then select the sensor or any virtual sensor they want to edit from the virtual sensor list 1312. Then, the user should press the tab control of their preference to specify if the virtual sensor is a Standard type, Timer type, or Variable type, as indicated by the displayed folder. The user can also press the “remove” button 1308 to delete the selected virtual sensor in the virtual sensor list 1312. Finally, the user can press the “apply” button 1304 to save their changes. The above functions are also illustrated (though not further described) in FIGS. 14 and 15. In the embodiment illustrated in FIG. 13, the “standard” virtual sensors do not have any other properties 1320 that would otherwise be defined in the standard tab 1314 of the virtual sensors dialog box 1300.

“Timer” type virtual sensors can be one of three types, as seen by the contents of the timer tab 1316 shown in the virtual sensor dialog box displaying timer tab 1400 illustrated in FIG. 14, according to a preferred embodiment of the present invention. User tab control provides the material located within the timer tab 1316 to appear superposed above the standard tab 1314 and the variables tab 1318. As seen in FIG. 14, the timer tab 1316 shows three fields for the three types of virtual sensors: (1) a simple repeating timer field 1402, (2) a fixed list of daily events field 1420, as well as (3) an equation based trigger timer field 1410 that includes a default message is off sub-field 1412 and a default message is on sub-field 1414. By checking the check box inside the simple repeating timer field 1402, the user can determine that the timer is a simple repeating timer. In the associated edit boxes, the user will enter the time in seconds for which the timer should remain on, and the time in seconds for which the timer should then remain off, until repeating the sequence.

In the equation based trigger timer field 1410, the user can specify that the timer is of type equation based trigger by checking the check box that is next to the word “when;” the system will then signal an action when the equation located therein is true. The equation is entered into the window immediately below the word “when.” Finally, the user must check one of the two check boxes located below the equation window. Either the default message is OFF (and the user should check the box next to the word ON in the default message is off field 1412, and enter the number of seconds that the ON message should persist), or the default message is ON (and the user should check the box next to the word OFF in the default message is on field 1414, and enter the number of seconds that the OFF message should persist).

If the user wishes the timer to behave according to a fixed list of daily events, the check box in fixed list of daily events field 1420 should be selected. The fixed list of daily events field 1420 also includes an edit box (for time), on, off and event list fields. When the check box is selected, the user may choose to add, remove, or insert events into the list via button controls. The events in the list can be selected, and the edit box should be used to specify the time, and the check boxes next to the words ON and OFF should be used to specify what the message should be.

As seen in the embodiment of FIG. 15, the virtual sensor dialog box displaying variables tab 1500 illustrates the variables tab 1318 superposed in front of the standard tab 1314 and the timer tab 1316. The variables tab 1318 can include: an equation field 1502 having a text box 1504 for an equation whose value is returned as the sensor reading, an initalization field 1508 having a “when” check box and a “when” text box 1510 as well as a “variable=” field 1512 (functionally, this field allows a user to set a variable to a specified value when a certain condition occurs; the variable can be set at initialization or at other times), and a variables field 1520. The variables field 1520 can include a “type” pull-down menu 1522, a name field 1524, an “add variable” button 1526, a variable/data field 1528, a “remove variable” field 1530, and a value field 1532. Variable type virtual sensors are similar to standard type virtual sensors, except that they provide an initialization equation, which, when satisfied, will change the variable value in the way defined in yet another equation. Also they will provide an incremental equation, which, when satisfied, will change the variable in the way defined in yet another equation.

### Devices: Properties and Manual Override

An exemplary “Devices Properties and Manual Override” dialog box 1600 is shown in FIG. 16, according to one embodiment of the present invention. This dialog box can include a device name area/field 1602, an available devices list 1604, a status list 1606, an ok button 1608, an apply button 1610, a cancel button 1612, and a selected device information area 1620. To edit or view the settings of a certain device, the user should select it from the list of available devices 1604 at the far left. Additionally, the status of all devices is listed in the status list 1606 immediately to the right of the available devices list 1604.

The selected device information area 1620 can include a manual override field (having an “overrride on” button 1622, an “override off” button 1624, and a “don't override” button 1626), a “turn this device on only if:” field 1630, a “turn this device off only if:” field 1640, a device parameter field 1650 (here illustrating the watts of energy consumed, but it could be any of the horticultural parameters contained in this disclosure or any other parameters, such as those related to any of the broad uses of the invention set forth), a linked sensors list 1652, and a messages list 1654 (which shows the messages that the sensors from the linked sensors list 1652 are currently sending to the selected device). Immediately above these lists, the user can specify the number of watts of energy that the device consumes when powered, or zero if it is a virtual device, according to the preferred embodiment of the present invention. The user may choose to override the device's behavior so that it will not respond to messages from sensors, and may do so by pressing the override on or override off buttons. The user may deactivate override mode by pressing the “don't override” button 1626, which will leave the device in the state it was overridden to be in, but will allow messages to change the state from that time on. The default behavior of each device is to respond to any message from any sensor, telling it to turn ON or OFF. If the user would like to change that behavior, they can specify that the device should turn ON only if ALL sensors send or have last sent an ON message by checking the check box next to the phrase “ALL sensors send ON”. Similarly, the user can specify that the device should turn OFF only if ALL sensors send or have last sent an OFF message by checking the check box next to the phrase “ALL sensors send OFF”.

### Virtual Devices

An exemplary virtual devices control dialog box 1700 is shown in FIG. 17, according to one embodiment of the present invention. This dialog box can include a name field 1702, a device field 1704, an add button 1706, a remove button 1708, an apply button 1710, an OK button 1712, and a series of tabs for choosing the “type” of a selected device. The user can create virtual devices by pressing the ADD button 1706. Selecting a virtual device in the list box on the left side of the dialog will allow the user to press the “remove” button 1708 to delete the virtual sensor.

As illustrated in the embodiment of FIG. 17, the “type” for each device can be given by a “.WAV” tab 1720, a “Network .WAV” tab 1722, a “Pager” tab 1724, or an “Email” tab 1726, and a user can change the settings and type of the virtual device by clicking on the appropriate tab control, then filling in the appropriate information. Additionally, the name of the selected virtual device can be specified. In the center of the displayed “.WAV” tab field, FIG. 17 shows the “.WAV File (audio alarm)” information, which can include a path field 1730 and a path features selection area 1732. According to this illustrated embodiment, the user should press the “set path” button (for the .WAV type of audio alarm), and they will be provided with a standard open file dialog box with which to specify the path of the microsoft WAV file they wish to use as the alarm. Then, the user will select one of the three radio buttons. The alarm will only sound once if the “One Shot” radio button is selected. The alarm will sound continually if the “Repeat until disable” radio button is selected. It will only cease to sound if whatever sensor(s) it is linked to stop sending an ON message, or it is overridden OFF. The alarm will repeat a specified number of times in a row in response to an ON message if the user enters a number of times in the edit box contained in the “Repeat (edit) times” radio button phrase and checks this radio button.

### Operations Flowchart

The overall functionality of the software, excluding user input and output routines, is described with a flow chart FIG. 18, according to the preferred embodiment of the present invention described hereafter in this section. Beginning at “Start”, the code represented by the chart will be executed every 500 milliseconds, or any other more preferable number of milliseconds. Until 1 second has elapsed since the last execution of the routine, the “Has 1 Second Elapsed?” block will branch to end the routine. After 1 second has elapsed, the routine will perform the remaining portion of the routine for every sensor that has been defined (“Check All Sensors” 1833). A subroutine is present to handle periodic updating of data, including file i/o, remote viewing/authorship capabilities, and settings changes. In the current embodiment the time interval is 15 seconds, but that number would be changed for higher or lower resolution functionality involving sensor and device states. If 15 seconds have not elapsed since the last time this subroutine was executed, the block “Have 15 Seconds Elapsed” 1834 will branch to no and follow the main routine. If 15 seconds have elapsed, the subroutine will first “Record Sensor and Device States, Check External File For Remote Changes, and Write New File For Remote Viewers/Authors” 1835. The sensor and device states, and file handling only occur once, before the sensors are checked to see if they are linked to the calendar. Afterwards, for each sensor the subroutine will check to see “Is The Sensor Linked To The Calendar?”. If it is not, the subroutine will terminate, and the main routine will resume for that sensor. If the sensor is linked to the calendar, the subroutine will set the “new maintain value” or set-point for the sensor (“Set New Maintain Value” 1838). At this point the subroutine will terminate, and the main routine will resume for that sensor.

The main routine is continued at block 1802 “Has Check Period Number Elapsed For Any Of The Sensors?” 1802. The sensor will only send messages or perform the other actions manifested by the remainder of the routine periodically. This time interval is called the “check period”, and if it has elapsed since the last time the main routine was executed for that sensor, the code will continue. Otherwise it will terminate.

If block 1802 returns true, the system will check “Is The Sensor A Timer?” 1804. If the sensor is a timer, a subroutine will handle the timer to see if it is time to send a message to any device(s). The subroutine first checks “Is The Sensor A Simple Timer?” 1822, and if it is, the subroutine continues to block 1828 “Send An On/Off Message”. If the sensor was found not to be a simple timer in block 1822, the subroutine will branch to block 1824 to handle a trigger type timer. The subroutine will “Parse Trigger Timer Equation” 1824, determining from the trigger equation if it is time for the trigger timer to send a message. The value of the trigger equation at that point in time will be evaluated in the following block to see “Is It Time To Send A Message?” 1826. If the equation returned false, it is not time to send any message, and the subroutine will terminate and exit without returning to the main routine. If the equation returned true, the subroutine will continue, and connect with block 1828 “Send An On/Off Message”. Both branches of the subroutine which handle the simple timers and trigger timers will reconnect at block 1828. If the sensor is a simple timer, that timer will send it's most current state (message) to linked devices depending on what type of simple timer it is. It may be a repeating on/off interval, or it might be a list of events. If the sensor is an equation based trigger timer, it will have determined it's desired message by evaluating it's equation. In either case the subroutine will terminate at this point, and resume the main routine at block 1856 “Send Message(s) To Device”

If Block 1804 “Is The Sensor A Timer?” returned false, the timer subroutine would be skipped, and the main routine would have continued at block 1806 “Is The Sensor A Variable”. Variable type sensors do not send messages, and a subroutine is provided to handle variable type sensor functionality. If “Is The Sensor A Variable” returns true, the subroutine will handle the variable type sensor, and then terminate without resuming the main routine. The subroutine will “Look At List Of All Conditions; Parse Equations” 1882. If any of the conditions return true (“Is Condition Met” 1884), the accompanying action equation for the condition will be used to update the variable value (“Parse Action Equation, And Set Variable To That Value” 1886). At That point the subroutine will terminate, and not resume the main routine. If no conditions are met (“Is Condition Met” 1884), the subroutine will also terminate, and not resume the main routine.

If block 1806 “Is The Sensor A Variable” returned false, the variable subroutine would be skipped, and the main routine would continue at block 1808 “Is The Sensor Of Type Equation” 1808. At this step, the sensor must be either a regular sensor (with an analog to digital input channel associated with it), or a virtual sensor (which must get it's value by using an equation, since it has no physical electrical signal associated with it). A regular sensor can use an equation to calculate it's value by including the variable “MV” for the number of millivolts it is associated with, if so it will be of type “EQUATION”. A virtual sensor must be of type “EQUATION”. If “Is The Sensor Of Type Equation” 1808 returns false, the sensor must be a regular sensor of a preset type, and the routine will “Use Preset Sensor Type To Convert Signal Into Units” 1812. If the sensor was of type “EQUATION”, block 1808 would branch to block 1816 and “Parse Equation To Convert Into Units” 1816. Either way, both branches in logic return the routine to block 1840, which asks “Is It Outside Tolerances?” 1840. At this block the routine will determine if the sensor reading in units is within tolerance levels of what the user has informed it is desirable. It the sensor reading is within an acceptable limit of what is tolerable, block 1840 “Is It Outside Tolerances?” will return false, and the routine will terminate. If the sensor reading is outside tolerance levels, the routine will resume at block 1842 to “Check List Of Linked Devices And Look For Correct Polarity Links” 1842. For every link associated with the sensor in question, the routine first checks to see if the link has a dynamic or static polarity. If “For Each Link, Is Polarity Dynamic?” 1844 returns false for the link, the routine skips to “Check Device Polarity For This Link” 1848 and retrieves the static polarity. If the link is dynamic, the routine moves from block 1844 to “Parse Link's Dynamic Polarity Equation” 1846, and then proceeds to “Check Device Polarity For This Link” 1848 with the determined dynamic polarity. Once the polarity of the link is known, the routine asks “Will Device Have A Helpful Effect To Remedy The Situation?” 1850. If the sensor reading is too low, a positive polarity link will be helpful, and visa versa. If activating the linked device would have an unhelpful effect, the device will be sent an “OFF” message (“Send “OFF” message” 1852). If activating the linked device would have a helpful effect, the device will be sent an “ON” message (“Send “ON” Message” 1854). Once the proper message to send has been determined for this regular or virtual sensor, the routine will proceed to “Send Message(s) To Device” 1856.

At block 1856 “Send Message(s) To Device”, the routine has arrived here from one of 4 types of sensors: Simple Timer sensors, Trigger Based Timer sensors, regular sensors, and virtual sensors. The subroutine which handles timer type sensors resumes execution of the main routine at block 1856, and the main routine continues execution at block 1856 in response to a regular or virtual sensor. At this point in the routine, the message(s) to be sent to device(s) have been determined. After the messages are sent by all sensors, the main routine will (for each device) “Look At A11 Messages Sent, Are Multiple Sensors Linked To This Device” 1860. If the device is only linked to one sensor, the routine will “Perform On Or Off Action And Maintain State” 1862 using the single message. If the device is named in more than one link to sensors, there are messages coming from multiple links. In this case the routine will “Perform Desired Action To Device Based On Logical Operation Of All Messages And Maintain State” 1864. By evaluating all the messages, and looking at the logical settings for the device, in conjunction with any equation based settings, the routine will determine the appropriate state for the device and set it as such.

Once the proper state for each device has been determined, at the prompting of messages coming from sensors, the routine will determine how to set the device to that state. That might mean powering an external relay to switch an electrical device, or if the device is a virtual device there would be another type of action. The routine first asks “Is Device A Physical Device” 1866, and if so, it proceeds to “Switch Physical Device State” 1870. If the device is not a physical device, it must be a virtual device, and the routine will “Perform Various Actions Depending On Virtual Device Type” 1868. Examples of virtual device actions would be, audio alarms, email, pages, telephone calls, or “action device” actions, which affect variable values contained in the system database. After the device state has been properly set for each physical or virtual device, the routine will terminate.

### II. Additional Invention Features

The configuration file for the invention is stored as a .RED file. All settings are recorded in this file. The system should be able to automatically load in a new file, periodically. This feature will allow the operation to change system functionality most fully, without an operator on hand. The feature makes it possible for the equations used by the system to be changed, and allows the relationships between the sensors and devices to take on different characteristics depending on climate needs. For example, if a crop has finished it's vegetative stage of growth, perhaps the climate desired would differ so drastically that the interrelationship between sensors and devices would need to function in a different way. Perhaps, a ventilation routine would not be necessary, to bring the CO2 level down in the atmosphere, and promote flowering. That might require that an internal cooling or heating mechanism would be activated for this phase of growth. Instead of having an operator reconfigure the system, the reconfiguration could be programmed as a different .RED file in advance. At the appropriate time, the new file would be loaded in. The condition for which the change should occur could be triggered by the start of a certain time and date, or be triggered by an equation. Perhaps, if the number of heat units was found to equal the right amount, the change would occur when an equation involving that variable returned true. Alternately, if the operator was expecting the change in a certain time period, they could pre program the change for the expected date.

The equations should be able to use the current date or any date and time as a variable. This would allow users more flexibility when defining circumstances that could effect decision-making.

In the devices dialog, devices will turn ON or OFF depending on messages it receives from sensors. Instead of having the choices ANY and ALL sensors sending an ON or OFF message, an equation could better represent all logical possibilities. There would be two equations; One for the ON behavior, and one for the OFF behavior. A new type of value would need to be defined in the parsing scheme for equations. By appending a colon, and the string MSG, the user would be able to access the value of the message coming from a sensor. For example: for a sensor called greenhousetemp, “greenhousetemp” would return the reading of the sensor at the moment, and “greenhousetemp:MSG” would return the message that the sensor is sending in the link relationship. “greenhousetemp:MSG” would return 1 for an ON message, and 0 for an OFF message. Therefore, an operator could define that the link would turn the device ON if (sensor1:MSG & sensor2:MSG)|(sensor1:MSG & (sensor1>70). This would mean that the device would turn ON if sensor1 and sensor2 send an ON message, or if sensor1 sends an ON message and sensor1's reading is above 70. In this way, the operator can manifest any behavior or relationship desired.

The tolerances feature might be expanded to account for different behavior when a tolerance level is approached with a rise or fall in sensor reading. For example, if a sensor reading is increasing, and it hits a lower tolerance level, it should notify any devices that it does not need their adjustment any more. However, if the level is falling, and falls below a lower tolerance level, it would instruct devices to turn ON or OFF to compensate. This value might differ from the rise tolerance level. Often this behavior is necessary to account for overshooting the right value. The rise tolerance might be lower than the fall tolerance, since often, and device's effect will continue to increase the value for a certain time after the device is turned off, like in the case of rising humidity. This might be due to a lag in the time it takes for the sensor to read the correct value, or a lag in the time it takes for the device's effect to effect the whole atmosphere. A lower rise tolerance value would anticipate increasing value even after the device stops it's action. This way, beginning when a rise in value is noticed, the device can stop at the appropriate time, and the value will still increase until it is at the right level. Also, the lower fall tolerance might need to be higher then the lower rise tolerance, because it would take a while for the device to counter the falling effect. Once this has happened and the reading begins to rise again, we will look at the rise tolerance so that we don't overkill on our adjustment. Finally, the values for these tolerances do not need to be static. Instead, they can be equation based. They might vary depending on sensor or variable readings, or the time of day or date. This mode would provide the most flexibility.

Action devices will be virtual devices that respond to an ON or OFF message by performing a mathematical operation on a variable. There will be two modes of operation. Either the device will perform the mathematical operation every time a redundant message is received, or only the first time a differing message is received. Each time an ON message is received, or the first time an ON message is received in a series of ON messages, a variable, associated with the action device, will be changed in a way described by an equation the user will enter for that type of event. The OFF messages will be handled in the same way, with another unique equation defined for that type of event For example, if an OFF message is sent, the equation will initialize the variable to zero, so the equation will be “0”. If an ON message is sent, increment the variable by one. The equation would be “(variable name)+1”. This scheme would track the number of successive ON messages sent, (assuming that the device is programmed to perform the operation every time a redundant message is received. It should also be possible to define 2 sets of ON and OFF equations, one set for initial differing messages, and another set for redundant messages.

Variables are a type of virtual sensor. Aside from any effect that an action device will have on a variable, there will be two types of operations that define and update the variable, initialization and incremental. If a certain equation returns true, the initialization mathematical operation will be calculated in the form of another equation. For example, if the time is 12 midnight, set the value to zero. There will also be a list box, where the operator can specify as many incremental conditions and accompanying mathematical operations as they like. For each item added to the list box, an associated equation will be specified as the trigger for the operation. If this trigger equation returns true, the system will use the accompanying equation to adjust the value of the variable. For example, if a sensor reading is above 100, add one to the variable.

In the sensors definition dialog. For each equation window there should be a drop down menu of pre-set equations. Things that would be commonly defined for that particular equation would be included, ie for a temperature sensor of a certain type, automatically fill in the right equation. This will increase the ease of use and lower the technical ability necessary to use the system. Equation windows could also have flexible usability. Mathematical terms for more advanced users, or simple words that represent a mathematical function for a less savvy user. A string could represent the desired pre-set equation, maybe the name of the type of sensor would suffice for known sensor types.

The fixed maintain value feature, for every sensor, which is defined in the sensors dialog, could be enhanced in functionality. Instead of entering a numerical value, the value could be equation based, so it will have the ability to function dynamically. The value might change based on time of day, other sensor readings, or variables. This feature would be called dynamic maintain values.

Additionally, several new values will be added to the equation parsing system through out the code. By appending the string “:maintain” to any sensor name, the return value would be the current maintain value requested by that sensor. An example would be “sensor1:maintain”. Also, appending the string “:playval” would return the current play log maintain value for a sensor that is linked to the calendar. This way, users can more easily use variations on the current play log within a sensor that is linked to the calendar. The maintain value for such a sensor “sensorA” might be calculated as “sensorA:playval+5”, and could be accessed elsewhere in logic as “sensorA:maintain”. Also, the values can be used in other places in the code where it might be necessary. For example, a device might use the value in it's logical scheme, where it's behavior would depend on the current maintain value of that sensor possibly in relation to time of day and variable values.

In the log generator feature, additional variables should be available. When calculating the play log to write to the calendar, the code will traverse all data points (which represent time slices). By entering “TEMPLATE:POSITION” the user will be able to access which time slice is currently being calculated. By entering “TEMPLATE:TOTALPOSITIONS” the user will be able to access the total number of time slices that exist. This scheme will allow users to perform specific calculations unique to each time slice, in addition to operations that effect each time slice in the same way. For example, a useful comparison would be “(TEMPLATE:POSITION/TEMPLATE:TOTALPOSITIONS)” which returns the ratio describing how far along the log file has been traversed. Ramp type behavior could be accomplished with variations on this example. Also, operations could only be accomplished if a condition were true. “TEMPLATE+(TEMPLATE:POSITION>20 & TEMPLATE:POSITION<400)*40” would add 40 units to the template value if the position were between 20 and 400. This is possible because in the logic scheme, a true comparison returns 1 and a false comparison returns 0.

The power usage and supply options could differ between low and high-end systems. The low-end systems would require 120V external power to operate. The high-end systems would have a variety of extra features. A power stepping CPU would save power, and allow the system to operate on low voltage power supplies. An included solar panel and battery pack might be offered, or the option to upgrade the system to include these features would be available in the high-end system. Also, the high-end system might include the ability to hibernate for periods of time, allowing the system to power on at intervals, perform adjustments, and then sleep again for a period of time. This would facilitate operation in areas where there is less power available, potentially out in the field. This might be especially useful if the system were installed as a data logger, with no 120V power nearby.

### III. Hardware Stratification

LCD screen and keyboard. A lower featured product might not include an LCD or keyboard at all. The user would need to link to the unit from a desktop machine to make changes or view readout. If an LCD screen and keyboard were to be present in all forms of the product they could differ in size and quality. A small monochrome LCD might suffice for a lower end product, and a larger, color LCD would make working with a professional grade system more pleasant.

The storage capacity and CPU speed of low end and high-end systems could differ. A low-end system might have a slower CPU, and less memory to store readings. This would mean that the unit could function in stand-alone mode for less time while retaining highly accurate data recordings. The unit could be programmed to record readings less frequently, to use the lower storage space more efficiently, but trading off recording accuracy. The high-end system would have a faster CPU. It would have more storage RAM, and potentially could include a solid state hard disk, which could store many more readings. It too could be programmed to record readings less frequently, potentially allowing it to remain in stand-alone mode for extended periods of time without losing much recording resolution.

The number of, type of, and quality of sensors and relays could differ in high end and low-end systems. A low-end system might only include a few stock sensors. These might be low accuracy, but sufficient for hobbyists or homeowners. The low-end system would probably not be upgradeable to allow more sensors to be added beyond a basic number of stock sensors and blank spots (possible a total of 8). The high-end system should include high quality, low drift, durable, accurate stock sensors. It should have more blank spots, so that it can be easily expanded to handle much larger operations. Also, it might have the option to add another card, increasing the number of sensors and devices available to the user. Similarly, the low-end system might include just a few relays for use with devices. They might be used to switch lower amperage loads, and there would be a limited number of 5 volt (TTL) outputs for use with additional relays that the user would be required to purchase separately. The high-end system would include a number of high quality, high load bearing relays. Potentially, even 240 volt relays to control high drain devices. The number of additional TTL outputs would be higher, and the optional add on card would provide many more device outputs.

The quality of the enclosure could differ between low and high-end systems. Low-end systems, such as those designed for homeowners and hobbyists, would be contained in a non-weatherproof enclosure, which could be cooled with an exhaust fan. These systems would be designed for indoor use, or would need an environmentally controlled room or enclosure to protect them from the elements. High-end systems would be waterproof, and could be cooled with heat sinks, which create a temperature differential between the inside and outside of the unit. The high-end systems could be placed in a greenhouse, or other extreme environment, like the outdoors.

The power usage and supply options could differ between low and high-end systems. The low-end systems would require 120V external power to operate. The high-end systems would have a variety of extra features. A power stepping CPU would save power, and allow the system to operate on low voltage power supplies. An included solar panel and battery pack might be offered, or the option to upgrade the system to include these features would be available in the high-end system. Also, the high-end system might include the ability to hibernate for periods of time, allowing the system to power on at intervals, perform adjustments, and then sleep again for a period of time. This would facilitate operation in areas where there is less power available, potentially out in the field. This might be especially useful if the system were installed as a data logger, with no 120V power nearby.

The high-end system could include several upgrade features not available in the low-end system. A Fiber optic RS232 card could allow fiber optic communication with a desktop PC up to 5 miles away from the unit. An external solid state disk drive would be able to store many months or years of recordings for later use. A GPS device could provide accurate positional and altitude data. A cellular data link could provide wireless communications, and potentially link systems to global weather services which might provide information that would affect logical decision making.

### IV. Applications/Uses of the Invention

### Mushroom Farming

The way that the invention was developed was through the growing of exotic mushrooms. This requires exacting climates that change in very specific ways depending on the species. This change depends on a wide variety of factors such as the climate, the devices available to change the environment, and the specific strategy to fruit a particular species. The general technique requires an environment with a high humidity, an even temperature, several fresh air exchanges depending on the CO2 level desired, and a low amount of light.

The invention was able to help control how these factors influenced one another, whereas another system would have had each device set and not able to respond to other devices, sensors, or relationships between them and time. For example, if the fresh air fan was too powerful for the humidifier (having a drying effect), short bursts during the daytime might be more desirable. At night, a longer burst might have less of a drying effect, assuming the ambient humidity was seen to rise at night as it tends to do. Also, lower temperatures might often mean less evaporative potential, further reducing the drying out tendency of the fan. Less electricity would be wasted if these devices were coordinated so that one device did not cancel out the others effect so considerably. Using the trigger based timer feature one could set up a scenario where in the day time hours the fresh air fan would work in one way and another way at night without ever having to reset the devices. Another manufacturer's system would have to be reset each day and night from the device control. If a manager got home and it was going to be a hot night and wanted to make this change a simple phone call form the home machine they would be able to make the change necessary using the remote feature. Alternately, an equation could be used which would adjust the timing interval depending on the time of day and the temperature. This mode would not require any adjustment by the user on a day to day basis.

The other aspect of a mushroom farm is the spawn-growing laboratory. In this laboratory there are many pressure vessels used to sterilize the substrates used for growing mushrooms. Most of these devices have built in control; however often they are not exacting as a mushroom scientist would like them to be, for scientific control purpose. Being able to have our pressure cooker controlled by the computer so that it overrode the built in controller allowed us to have exact control without having to watch it. This is accomplished by setting a maintain value. Most importantly, if from the office where a manager needed more time they would be able to change the setting and draw a new graph, or make set a new maintain value. Thereby, the pressure vessel could be set up to drop in pressure slowly and hold at a low pressure, or just set a low value and have it being maintained at the new pressure until he/she is ready to go in the lab and use the sterilized medium. This allows an employee who previously had to watch the pressure vessel to do other work. Additionally, an alarm could be sounded so at a certain pressure the employee is alerted to the fact that the medium is done cooking and ready for use.

Another aspect of mushroom farming that applies more broadly than just mushrooms, but is essential in a successful flush of mushrooms is composting. It is imperative in almost all composting systems that the compost reaches and maintains around 156 degrees Fahrenheit for several days. Using the invention would help in a variety of ways. Sensors could sound alarms if the compost were too hot, too cool, too dry or too wet. Some of most of these situations would require that the compost be turned, but if more advanced system were in place the control of that device could be done using the invention. Using the invention in this way would make it easier for staff to be assured that the correct temperature is maintained, adding more control to the composting. This would assure a higher quality end product, whether it is to be used as fertilizer or for mushrooms to grow on. Also, this degree of certainty would help when organic farmers have to use non-organic ingredients that they have to compost thoroughly. Our system would provide the record needed by certification organizations.

### Hydroponics

The field of hydroponics is a fast growing agricultural art, whose popularity is catching on world wide at a growing rate. There are many different forms that hydroponics takes, but in general the roots are grown in water, generally in a greenhouse environment. Many of the parameters that the invention would record and control is the same types of components controlled in a greenhouse. So when talking about hydroponics it makes sense to talk about greenhouses in general, and then we can talk more specifically about the different types of hydroponics and why the invention is a superior idea than the prior art.

Greenhouses have a wide array of factors that are controlled by many different devices. These factors are namely: light, CO2, temperature, humidity, soil moisture, and nutrient levels. The devices that generally control these factors are retractable shade cloth, grow lights, CO2 injection systems, fans, air conditioners, heaters, humidifiers, misters, irrigation, and nutrient injectors. Depending on the crop a variety of these factors are monitored and devices used to control them. Even with a handful of these devices and factors the interrelationships can be complicated. Basically said, a system that works with static control my be defeating the desired outcome, whereas a system like the invention can be programmed by the user so that any possible interrelationship can be manipulated to work in the most efficient way. This will lower labor, save inputs, and increase yield.

An example of greenhouse control is in measuring the transpiration and CO2 relative to using shade cloth and irrigation systems. A sensor can be used to find out how much transpiration is occurring, or how much water is leaving the plant through the leaf. This factor could be held relative to data known about how much CO2 is absorbed by a plant in a sunny environment and a shady environment. Having the irrigation come on relative to the transpiration could be desirable for some plant species. Depending on its CO2 requirement shadecloth would help keep the moisture in the soil and therefore lower transpiration, but would lower the absorption of CO2. In the full sun the soil would dry out and transpiration would increase. By using a transpiration sensor, a light sensor, and a CO2 sensor the invention would be able to find a happy medium depending on the desire of the grower and the need of the plants. This would be possible by having the CO2 output equal the absorption rate relative to the need of shade cloth determined by the transpiration.

All of these greenhouse conditions affect the way a hydroponics system works, but with a hydroponics system there are even more factors. In general hydroponics has roots growing in water. The control of the water becomes very important to plant health, as there is no soil. The way the plant gets all its nutrients is through the water and it is measured using an electrical conductivity sensor. Other factors that are monitored are the water temperature, the dissolved oxygen, and the pH. Heaters and aerators control these factors, with solenoids controlling the pH and nutrient adjustment. There are pumps that deliver the water to the delivery system, which varies depending on the type of hydroponics art employed. When you add all of these parts of hydroponics to the control of a greenhouse the relationships become even more complex. Our flexible system makes the ability to relate these conditions together in any logical way desirable for the grower. As plants that are more difficult to grow are grown using hydroponics these complexities become more important.

An example of how our system would work better than another system in hydroponics setting is through the ease of collecting data and responding to it all from the setting of an office. Being able to monitor the whole system form a remote computer a manager could see the effect that one parameter is having on another. For an example if the weather changes, or how one fan affects humidity or temperature. Adjustments can be made no matter the relation between the factors. Other systems do not allow you to see how the air effects humidity. We would simply set up a view configuration that would give us that information in graphical format, telling us what was being turned on and off, how often and the sensors allow a correlation so better more cost effective decisions can be made, all by remote. Other systems leave operators guessing or walking around with hand held measurement devices and trying to correlate parameters in ones head.

### Aquaculture

Another related agricultural art is aquaculture, or the growing of fish and plants in controlled pools. The exact measurement of water factors is key to maintaining a health system and quality products. In this system the waste from the fish is utilized as nutrients by the plants. Many of the same factors are monitored and controlled as in a hydroponics system. The water has to be changed or flushed through in cycles our system could monitor this system and then sound an alarm when a variety of factors indicated that it was time to do this manual process. The difference is that our program could be monitoring and weighing a more broad set of factors to very exacting degrees and holding each of them relative so that this process would not be done until it actually was demanded by the system, saving time and resources.

### Row Crops

There are of course a wide variety of crops grown in the field for which our system could be helpful. In monoculture agriculture things are more straightforward, but if a farmer were trying to do a system of sustainable or organic agriculture that is more complex, a system created for a monoculture crop rotation would be insufficient. If a farmer were trying to grow many things in the same field or production area a tool to help track all of the effects of inputs on the soil, for example. Our system would be able to track these differences and adjust inputs slightly for one of the crops that would not adversely effect the other crops. Other control systems are only set up to handle a system that is linear. Our system is set up to handle linear as well as more dynamic systems.

### Process Control

The other area of agriculture that our system is useful is in the processing sector. In the making of fermented products such as cheese and wine there is the need for exact measurement and timing. Oxygen, CO2, and temperature are just a few key factors. Fermentation processes, as an example of other agricultural processing, is a process with many factors that need to be maintained accurately. These systems function best if they are slowly ramped down over time in a exacting way. Our system would be easy to adapt to a variety of these controls type mechanisms.

### Home Control

A home version of our system would be a useful tool for a variety of things. It could water indoor plants, gardens, or landscaping. Our system would be able to set it up in a way that would allow for the fact that some plants need to be watered daily and others need to be watered infrequently. Adding a more solenoids and making separate systems it could easily be done. Allowing one to check in on the houseplants or garden while on vacation form a remote setting. The other ways it could be used in a house would be for small versions of big agricultural operations.

### Scholastic Applications

A version of our product could be used in schools in a variety of ways. In a simple for it could be used to aid students in tracking certain parameters and give them sets of data to work with, while at the same time controlling an environment growing something useful. A more sophisticated student could use it as a tool to help control environments so that they are sure of a control and know that if the factor they change is responsible for the outcomes they record. In this same way it would help collect the data to prove this point and make it easier for other scientists to reproduce the results or not. This could be boon to scientists because it is a difficult thing to do setting up experiments in exactly the same way with a secure control.

### Heat Units

In agricultural sciences, the amount of ambient heat noticed during a series of days, weeks, or months, is often measured in what are called heat units. Often, the maturity level of types of crops is measured in these units, which represent the total amount of heat that the environment has experienced in a certain number of days. Also, pests have been found to hatch when a certain number of heat units has been experienced in that environment, from a certain reference date. Roughly, one method of gauging the number of heat units experienced during a day is to take the maximum temperature noticed, subtract the minimum temperature noticed, and divide by two, giving the average temperature, and subtracting a base temperature depending on the method in which other data was collected. This is a very crude method. Other curve fitting techniques are used, and it is possible that one could get a more accurate reading by taking the average of many data points collected throughout the day. The Invention could easily track the number of degrees of temperature recorded every 15 seconds in it's log files, and take the average for the day, providing a highly accurate reading. A variable could be defined, which would behave in the following way. It would initialize itself at 12:00 midnight by setting it's value to zero. When the time in seconds was found to be divisible by 15 exactly, the current temperature would be added to the variable. At the end of the day, when the time was 11:55:45, the variable would divide itself by the number of readings it had taken (5760 or so). The exact number of readings taken could be a variable as well, which would be set up exactly the same as the heat units variable, but every 15 seconds or whatever resolution it was set for, it would only increment it's value by one unit, thereby tracking the number of times a temperature reading was added to the heat units variable).

By creating a Heat Units variable, users of the invention would be able to collect high resolution data, and set up alarms which would notify when crops were mature, or when pests were likely to hatch. By linking their unit to our main website, users could download information on crop and pest data, which could help them maintain a healthy crop. This could result in higher crop yield, and more savvy techniques. As more and more high-resolution data is collected by our systems, it can be uploaded to our main site, and be added to the library of information, which will be accessible to the public. If the user of the system decides to use pesticides, they will likely need less pesticide, and instead of spraying arbitrarily or when pests are noticed in abundance, they can take more carefully timed applications of pesticide, potentially using less. Also, there are a number of organic techniques that can be applied if prior knowledge of a bug hatch is available. A crop can be covered with a certain type of fabric for the days that the bugs are hatching, and since the life span of many pests numbers only in a few days, the pests can literally be physically separated from the crop, until they die naturally. In a greenhouse situation, it is often the case that environmental conditions can be altered by raising or lowering the temperature or other factors, so that it is inhospitable to the bug that is hatching, but it is still acceptable for the plants in the same environment. After the hatch, the conditions in the greenhouse could be returned to one that may be more optimal for the growing of the plants. Many organic pesticide alternatives which are less potent than non-organic pesticides could also be more effective if they were applied at exactly the right time, with the help of the information the invention supplies.

### Reproducing Conditions Recorded from the Wild

The invention has the ability to record and playback an environment over a long period of time. Many delicate types of plants and fungus require environments that are extremely difficult to reproduce. In fact, many types of mushrooms have not been successfully cultivated outside of the wild. The invention can be installed in a location where information is needed, where the plant or fungus is found in the wild. Afterwards, reproducing the environment would be simple. Current technology would require that an operator re-set a fixed stat system periodically, while our system would automatically play back all the conditions noticed every 15 seconds during the recording phase. Most scientists complain that they cannot provide conclusive data summaries when working in the wild, because there is simply not enough data collected. Our system can remedy this problem. If every user of our system were to record their ambient environmental conditions as well as the conditions of their crop, they could choose to upload that information to our main site. That library of very high-resolution information could be essential to aid scientists in their understanding of our fragile ecosystems. It might provide insights into trends and predictions about future patterns, and help assess damage that was being done to the stability of a climate or microclimate. This information could help individuals plant crops that would be most suitable for their climate, and also it could help us learn how to protect our natural resources, and the stability of our global ecosystem.

### Sophisticated Timer Integration

By linking a sensor to a device, the user of the invention can create a feedback loop that will adjust the condition sensed by powering the device or not powering it. If a more sophisticated “ON” behavior is required, the user could link a timer to the device as well as the sensor, and specify that the device should turn “ON” only if all sensors (the timer is considered a sensor) send an “ON” message. The user would also specify that the device would turn “OFF” if any sensor sent an “OFF” message. This was the “ON” behavior would actually manifest itself in bursts of “ON” and “OFF”, which might be desirable.

### Dynamic Polarities and Check Periods Used to Prevent Freeze Up in an Air Conditioning Unit.

On a very cold day, if an air conditioning unit is working very hard, the exterior part of the unit can freeze up, which renders the device ineffective. The only way to prevent freeze up, is to turn the unit off for a small time, so that the ice can melt, and the freon can warm up slightly. A way to accomplish this would be to create a virtual sensor that would be linked to the air conditioner, as well as the main sensor which was linked to the air conditioner. For example in our laboratory, we have a temperature sensor linked to the air conditioner. If we created another virtual sensor which specified in it's equation that it was the same value as the lab temperature sensor, it could help us to prevent freeze up. The normal lab temperature sensor would be linked to the air conditioner device, and it's link would have a negative polarity, since it would lower the temperature when activated. The virtual sensor would also be linked to the air conditioner. It's link would have a dynamic polarity. If the temperature recorded by an outside temperature sensor was above, say, 40 degrees, we would have to worry about the air conditioner freezing up. In that case, we would want the polarity of it's link to be positive, so that it would send an OFF message to the air conditioner. The air conditioner should be set up to turn ON if any sensors send an ON message, and OFF if any sensor sends and OFF message. This creates a schism, where conflicting messages are being sent. If we set the check period of the regular sensor to 3 minutes, and the check period of the virtual sensor to 9 minutes, then we get the following behavior. When the outside temperature is above 40 degrees, both the normal and virtual lab temperature sensors will have a negative polarity with respect to the air conditioner, and the normal sensor will send it's message every 3 minutes, before the identical message coming from the virtual sensor will arrive, every 9 minutes. If the outside temperature is below 40 degrees, the polarity of the virtual sensor will be positive, so it will send a conflicting message every 9 minutes. The air conditioner will therefore stay ON for 9 minutes, until the virtual sensor sends an OFF message. Messages are sent in the order that the sensors appear in the sensor list. (in the future, users will specify which sensors should appear where in the order of messages sent). Since virtual sensors appear after normal sensors, at 9 minutes, the normal sensor will send an ON message, and immediately afterwards, the virtual sensor will send and OFF message, and that will be the last message sent during at that time. It will remain OFF for another 3 minutes, before the normal sensor's check period is up and a new ON message is delivered. This way, when the temperature outside is below 40 degrees, the ON behavior of the air conditioner will really manifest itself as 6 minutes of ON time, 3 minutes of OFF time to prevent ice up.

### Variables and Action Virtual Devices Used to Prevent Freeze Up in an Air Conditioning Unit.

Alternately, we might also be able to track the time that the air conditioner was successively on with a variable. That variable would count the number of time slices that the air conditioner was found to be on.
We could link the sensor measuring the temperature, which is linked to the air conditioner, to another device as well. It would be linked to a virtual device of type ACTION. The action type device would perform an incremental calculation on a variable it was linked to. Each time it received an ON message, it would add 1 to the variable's current value. Each time it received an OFF message it would set the variable's value to zero. Based on the check period of the sensor sending it messages, the user could tell how many minutes of on time successively the device had seen! Then, we could make a virtual sensor of type equation based trigger timer. It's condition would be, if the variable was a certain level (meaning that the air conditioner had been on for a certain time period), send an OFF message for a certain time. Otherwise, the timer would send an ON message. The temperature sensor would send an ON signal, or OFF signal as needed, but the device would only respond to an ON, if ALL sensors sent an ON signal, and it would turn itself OFF if ANY sensor sent an OFF message. We could also specify in the trigger timer equation, that the variable must be above a certain amount, and the temperature outside must be below 40 degrees. This would provide the highest level of control.

### Dynamic Polarities Used to Incidentally Heat or Cool a Greenhouse While Performing Ventilation by Selecting One of Two Possible Intake Fans

Imagine a scenario where a farmer has a greenhouse that must be ventilated periodically thorough out the day. If that greenhouse had fans installed at the top of the greenhouse, and also at the bottom of the greenhouse, the farmer would be able to control the temperature incidentally, while performing the ventilation. This technique would save power, reducing dependency on other devices to control greenhouse temperature. The means of accomplishing this task could be implemented through dynamic polarities. A single temperature sensor measuring the air temperature in the greenhouse would be installed. Also, temperature sensors would be installed immediately outside the greenhouse, one near the lower intake fan, and one near the upper intake fan. A Virtual Sensor of type Timer would be created in the software, and it would be linked to both the upper and the lower fan. At an interval, it would send ON or OFF messages to the fans. In order to determine which fan to use, the system would link both of the fans to the greenhouse air temperature, and specify that they should only turn on if ALL sensors send an ON message, and turn OFF if ANY sensor sends an OFF message. Next, the two links from the greenhouse air temperature to each of the fans would be set up so that at any time, the polarity of the two is different. The greenhouse air temperature sensor would be set to maintain a certain temperature. The dynamic polarity would work as follows.
The upper fan would be positive polarity if: (upperfan>greenhouseair AND upperfan>lowerfan) OR (lowerfan<greenhouseair AND upperfan<greenhouseair AND upperfan>lowerfan).
Similarly, the lower fan would be positive polarity if: (lowerfan>greenhouseair AND lowerfan>upperfan) OR (lowerfan<greenhouseair AND upperfan<greenhouseair AND lowerfan>upperfan).

With this setup, the system will work in the following way. When the timer sends an OFF message to both fans, they will turn off regardless of any messages being sent by the link to the greenhouse air temperature (since all sensors must send an ON, and the timer which is considered a sensor, is sending OFF to both linked fans). When the timer sends an ON message to both fans, only one of the fans will turn on.

If the greenhouse is too hot, the greenhouse air sensor, which is linked to both devices will look for a negative polarity device. If it is too hot outside, it will mark the cooler of the two fan air temperatures as negative polarity, thereby heating the greenhouse as little as possible. If one fan air temperature is hotter than desired in the greenhouse, and the other is colder than desired, the system will pick the colder one as a negative polarity device, and begin to cool the greenhouse. If both of the fan air temperature sensors are colder than in the greenhouse, the system will pick the coldest fan air temp and mark it as negative polarity, thereby cooling the greenhouse the most and the fastest.

If the greenhouse is too cold, the greenhouse air sensor, which is linked to both devices, will look for a positive polarity device. If it is too cold outside, it will mark the warmer of the two fan air temperatures as positive polarity, thereby cooling the greenhouse as little as possible. If one fan air temperature is cooler than desired in the greenhouse, and the other is warmer than desired, the system will pick the warmer one as a positive polarity device, and begin to heat the greenhouse. If both of the fan air temperature sensors are warmer than in the greenhouse, the system will pick the warmest fan air temperature and mark it as positive polarity, thereby heating the greenhouse the most and fastest.

### Fixed Polarities Used to Incidentally Heat or Cool a Greenhouse While Performing Ventilation by Selecting One of Two Possible Exhaust Fans.

Another factor of ventilation involves exhaust fans. The described ventilation scenario so far only describes operation of air intake fans, but exhaust fans can also play a part in incidentally heating or cooling a greenhouse. The setup could also include two exhaust fans, linked to the ventilation timer, and linked to the greenhouse air temperature. They would operate in the same manner, except that they would have fixed polarities. The upper fan would exhaust the hotter air from the top of the greenhouse, therefore having a negative polarity. The lower fan would exhaust the cooler air, therefore retaining the most heat in the structure, giving it a positive polarity. Depending on the current desired air temperature in relation to the actual air temperature in the greenhouse, the ventilation exhaust mechanism would incidentally retain heat or cool the greenhouse.

The many potential uses of the invention are not set forth in full detail herewithin. However, we describe some of these applications briefly. Many emerging technologies are currently in the research and development phases (See Appendix A—“EPA Strategy For Promoting US Environmental Exports,” which illustrates the importance of the present invention as it fulfills the goals recited therein). Appendix B “A Road Map For Natural Capitalism” illustrates the need for efficient, sustainable technologies, and their importance in future economic development. An exemplary application would involve a subsidiary corporation to handle each particular application of the invention. If we define each subsidiary corporation, we could get teams of people to work on them. All potential uses of the invention should be outlined. It might seem like common sense to us, but we need to get the message across to others, who have not been discussing these ideas.
Fuel production—methane from compost—heat generated from composting operations
Bioremediation
Reforestation
Food production to feed the hungry with limited resources consumed, used, available.
Medicine creation technology. Fungus, Herbs.
Sustainable technology systems. Closed ecosystems, permaculture, water conservation. Filling and better managing water tables
Water conservation (part of all systems)
Fish Farming (actual market)
Home controls. Efficiency. (actual market with lots of competition)
Passive systems. Compost to heat, other systems to heat, cool etc
Compost, reduce waste output, provide heat and fuel (Possible part of a home or agricultural operation)
Desalinization (research stage mostly)
Crop rotation technology and know how. Simple monitoring of soil structure and constituents.
Weather anticipation to conserve resources. Satellite data and on board weather station. Ie look at other weather stations and include in basic model. All people like to know their local weather.
Crop recommendations for the unique microclimate. A data based idea, possible outcome of data collection in the future, linkage to libraries of information. Mostly applicable to grow the most food possible in a region. Other factors usually overshadow type of crop, like market state, cost/profit analysis for professional operations. This could be useful for non-professional operations designed to produce the most food possible in a location, whatever the food type.

Many of these technologies are in states of research. Therefore a system like ours would help those who do the research. Find an organization or several organizations to work with. Rocky Mountain Institute is an excellent example. They work on many of these sustainability issues. We could promote ourselves and our techniques/ideas through this type of interaction. Essentially these types of applications fall under a scholastic type product made for PhD's and graduate students or undergraduate or institutions doing research.

Ideally, these technologies could help to build economic stability. By producing more food locally, we reduce our dependence on fossil fuels needed to transport food. By producing useable soil, conserving water, and promoting energy efficiency, we can create more closed systems of existence. Overall, conserving resources and energy, and providing a cleaner healthier environment.

### Problems and Solutions

A major problem when gardening is forgetting to water the crops. One day of direct sun with too little can wilt leaves, and the crop will never be as healthy as it could have been. With the invention, agricultural operators can be sure that they will never damage their crop in this way.

Watering crops during the day wastes lots of water. The invention can pick the right time to water. This will increase efficiency in areas where water is scarce.

If it's raining, the system will determine that the crop does not need to be watered. Too much water can damage a crop, and it wastes water.

Agricultural operators will be able to make good use of the log files generated by the invention. They will know exactly what happened when, and be able to best reproduce ideal conditions, and also determine what problems happened when, if that's the case.

The ability to reproduce exactly the proper conditions occurring during a successful crop cycle will greatly aid agricultural operators.

They system may also be able to determine when a crop or environment is mature, or will die soon anyway and does not need any more resources added to it, automatically. It might be fall, and watering a tree that will soon lose all its leaves would not be prudent.

Reproducing or generating exactly the right climate will facilitate the highest crop yields and the most healthy plants.

The following glossary of terms is set forth, primarily for those not of ordinary skill in the art. Any “computer” can also refer to a corresponding computer system.

Sensor—May refer to either a physical electronic sensor or a virtual sensor entity. A physical sensor will mean a means of gathering data from the physical world and converting it into electronic data, e.g. a temperature sensor. A virtual sensor will mean a sensor who's value is determined by other sensor values, variable values, or by dependencies on other linkable entities or device states e.g a timer.
Device—May refer to either a physical device, or a virtual device entity. A physical device will be a switchable electrically powered mechanism, such as a fan. A virtual device will mean a device entity contained within the software environment, who's action affects the other entities within the software environment, and or transmit information to users. An example would be an audio alarm, or an action device which will modify variable values.

### Implement/Implementing—Refers to the process of defining, updating, and maintaining the software environment and the entities and relationships within the environment.

Abstract Linkages—Refers to the interrelationship properties and rules between the linkable entities within the software environment. Determining the necessary actions and decision making in order to manifest the environmental control platform.
Relationship—Refers to an instance where one entity affects another in some way. For example, a temperature sensor value may affect device behaviour, such as fans or heaters, that will adjust the temperature. Another sensor might be affected by a variable which in turn is dependent on other sensor variables over time. These are all relationships.

### Interacting—Computer operation and data processing that relates to controlling, reading, operating, sampling, changing settings.

### Environmental Outcome—The end result in physical environment, or a level that the data is desired to be at a certain time.

Controllers—An exemplary controller that is referred to in claims is any piece of control related hardware. An example is a thermostat, which controls a device to maintain a certain temperature.

### Drawing Tool Functionality—Refers to standard drawing tool functionality found in common editing applications, such as Photoshop®.

In the foregoing, a system and method has been described for controlling environments. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense. With regard to the claims appended to this PCT application, it is noted that the full range of system, as well as method and article of manufacture claims in particular, have not been included with this application at this time in order to control costs for this small entity client. Method and article of manufacture claims corresponding to the entire range of recited system claims, as well as others, are contemplated.

1. A system for controlling an agricultural operation, comprising: control-related elements, including one or more sensors that may sense one or more environmental conditions, and one or more devices that may effect the one or more environmental conditions; optionally, one or more variables, wherein the one or more variables and the control-related elements are collectively referred to as linkable entities; a control computer that manages sensor data and affects the state of the one or more hardware devices; and machine executable programs of instructions including a control process that provides for abstract linkages and relationships to be implemented among the linkable entities.

2. The system of claim 1, further comprising a data processing device that is connected to the control computer via a communication link, and is capable of remotely interacting with the one or more sensors and the one or more devices.

3. The system of claim 1, wherein the machine executable programs of instructions include a data manipulation process that can record and play back sequences of environmental conditions.

4. The system of claim 1, wherein the machine executable programs of instructions include a data manipulation process that provides editing functionality, including cutting, copying and pasting of environmental data.

5. The system of claim 1, wherein the machine executable programs of instructions include a data manipulation process providing drawing tool functionality that allows the user to graphically indicate desired environmental conditions.

6. The system of claim 3 wherein the data manipulation process is effected by object-oriented programs of instructions.

7. The system of claim 1, wherein the system possesses an expandable nature characterized by the ability to add additional control-related elements without adding additional controllers.

8. The system of claim 1, wherein the system possesses an expandable nature characterized by the ability to add additional control-related elements, and allow the control process to implement the added control-related elements along with the existing linkable entities.

9. A system for controlling an agricultural operation, comprising: control-related elements, including one or more sensors that may sense one or more environmental conditions, and one or more devices that may effect the one or more environmental conditions; optionally, one or more variables, wherein the one or more variables and the control-related elements are collectively referred to as linkable entities; a control computer that manages sensor data and affects the state of the one or more hardware devices; and wherein the system possesses an expandable nature characterized by the ability to add additional control-related elements, and allow the control process to implement the added control-related elements along with the existing linkable entities.

10. The system of claim 9, further comprising a data processing device that is connected to the control computer via a communication link, and is capable of remotely interacting with the one or more sensors and the one or more devices.

11. The system of claim 9, further comprising machine executable programs of instructions including a data manipulation process that can record and play back sequences of environmental conditions.

12. The system of claim 9, further comprising machine executable programs of instructions including a data manipulation process that provides editing functionality, including cutting, copying and pasting of environmental data.

13. The system of claim 9, further including machine executable programs of instructions include a data manipulation process providing drawing tool functionality that allows the user to graphically indicate desired environmental conditions.

14. The system of claim 9, wherein the expandable nature is further characterized by integrating of the added control-related elements into the group of linkable entities that are available for abstract linkages and interrelationships.

15. The system of claim 9, wherein the relationships and abstract linkages among the control-related elements can be reconfigured to be dependent upon any of the linkable entities.

16. A system for controlling an agricultural operation, comprising: control-related elements, including one or more sensors that may sense one or more environmental conditions, and one or more devices that may effect the one or more environmental conditions; a control computer that manages sensor data and affects the state of the one or more hardware devices; and machine executable programs of instructions including a data manipulation process that can record and play back sequences of environmental conditions.

17. The system of claim 16, wherein, in conjunction with the data manipulation process, the sequences of environmental conditions are played back at a later time on a graphical user interface for manipulation by a user.

18. The system of claim 16, further comprising a data processing device that is connected to the control computer via a communication link, and is capable of remotely interacting with the one or more sensors and the one or more devices.

19. The system of claim 16, wherein the machine executable programs of instructions include a process that provides editing functionality, including cutting, copying and pasting of environmental data.

20. The system of claim 16, wherein the machine executable programs of instructions include a process providing drawing tool functionality that allows the user to graphically indicate desired environmental conditions.

21. The system of claim 16, further including zero or more variables, wherein the zero or more variables and the control-related elements are collectively referred to as linkable entities.

22. The system of claim 21, wherein the expandable nature is further characterized by integrating of the added control-related elements into the group of linkable entities that are available for abstract linkages and interrelationships.

23. A system for controlling an agricultural operation, comprising: control-related elements, including one or more sensors that may sense one or more environmental conditions, and one or more devices that may effect the one or more environmental conditions; and
a control computer that manages sensor data and affects the state of the one or more hardware devices; and machine executable programs of instructions including a graphics process that effects the display, on a graphical user interface, of sensor information in linear association/correspondence with device state data.

24. A system for controlling an agricultural operation, comprising: control-related elements, including one or more sensors that may sense one or more environmental conditions, and one or more devices that may effect the one or more environmental conditions; and a control computer that manages sensor data and affects the state of the one or more hardware devices; and machine executable programs of instructions including a graphics process that effects the display of sensor information on a graphical user interface in groups, wherein the group is comprised of sensor data pertaining to a desired relationship.

25. A system for controlling an agricultural operation, comprising: control-related elements, including one or more sensors that may sense one or more environmental conditions, and one or more devices that may effect the one or more environmental conditions; and a control computer that manages sensor data and affects the state of the one or more hardware devices; and machine executable programs of instructions including a graphics process including a zoom tool that allows a user, via a graphical user interface, to display relevant and/or different ranges of data.

26. A system for controlling an agricultural operation, comprising: control-related elements, including one or more sensors that may sense one or more environmental conditions, and one or more devices that may effect the one or more environmental conditions; and
a control computer that manages sensor data and affects the state of the one or more hardware devices; and machine executable programs of instructions including a calendar process that effects the display of environmental information on a graphical user interface in association with the day it occurred, wherein a user can select a particular day to view the environmental information that transpired on that day.

27. A system for controlling an agricultural operation, comprising: control-related elements, including one or more sensors that may sense one or more environmental conditions, and one or more devices that may effect the one or more environmental conditions; and a control computer that manages sensor data and affects the state of the one or more hardware devices; and machine executable programs of instructions including a calendar process that enables user selection, via a graphical user interface, of a particular date to display the desired sensor information for that date.

28. A system for controlling an agricultural operation, comprising: control-related elements, including one or more sensors that may sense one or more environmental conditions, and one or more devices that may effect the one or more environmental conditions; optionally, one or more variables, wherein the one or more variables and the control-related elements are collectively referred to as linkable entities; a control computer that manages sensor data and affects the state of the one or more hardware devices; a machine executable program of instructions that provides for abstract linkages to be created among the linkable entities; and a machine executable program of instructions that provides a control routine process that evaluates the control-related entities and their linkages to determine if any action is necessary.

29. A system for controlling an agricultural operation, comprising: control-related elements, including one or more sensors that may sense one or more environmental conditions, and one or more devices that may effect the one or more environmental conditions; optionally, one or more variables, wherein the one or more variables and the control-related elements are collectively referred to as linkable entities; a control computer that manages sensor data and affects the state of the one or more hardware devices; a machine executable program of instructions that provides for abstract linkages to be created among the linkable entities; and a machine executable program of instructions that provides a control routine process that updates and maintains statistical information related to the linkable entities, and evaluates the control-related entities and their linkages to determine if any action is necessary.

30. A system for controlling an agricultural operation, comprising: control-related elements, including one or more sensors that may sense one or more environmental conditions, and one or more devices that may effect the one or more environmental conditions; optionally, one or more variables, wherein the one or more variables and the control-related elements are collectively referred to as linkable entities; a control computer that manages sensor data and affects the state of the one or more hardware devices; a machine executable program of instructions that provides for abstract linkages to be created among the linkable entities; and a machine executable program of instructions that provides a control routine process that implements relationships and provides for the creation of abstract entities among the linkable entities.

31. A system for controlling an agricultural operation, comprising:
control-related elements, including one or more sensors that may sense one or more environmental conditions, and one or more devices that may effect the one or more environmental conditions; optionally, one or more variables, wherein the one or more variables and the control related elements are collectively referred to as linkable entities; a control computer that manages sensor data and affects the state of the one or more hardware devices; and a machine executable program of instructions including a data manipulation process that can record and play back sequences of environmental conditions.

32. A system for controlling an agricultural operation, comprising: control-related elements, including one or more sensors that may sense one or more environmental conditions, and one or more devices that may effect the one or more environmental conditions; optionally, one or more variables, wherein the one or more variables and the control related elements are collectively referred to as linkable entities; a control computer that manages sensor data and affects the state of the one or more hardware devices; and machine executable programs of instructions including a data manipulation process which provides drawing tool functionality that allows the user to graphically indicate desired environmental conditions.

33. A system for controlling an agricultural operation, comprising: control-related elements, including one or more sensors that may sense one or more environmental conditions, and one or more devices that may effect the one or more environmental conditions; optionally, one or more variables, wherein the one or more variables and the control related elements are collectively referred to as linkable entities; a control computer that manages sensor data and affects the state of the one or more hardware devices; and wherein the system possesses an expandable nature characterized by the ability to add additional control-related elements without adding additional controllers.

34. A system for controlling an agricultural operation, comprising: control-related elements, including one or more sensors that may sense one or more environmental conditions, and one or more devices that may effect the one or more environmental conditions; optionally, one or more variables, wherein the one or more variables and the control-related elements are collectively referred to as linkable entities; a control computer that manages sensor data and affects the state of the one or more hardware devices; and wherein the system possesses an expandable nature characterized by integration of the added control-related elements into the group of linkable entities that are available for abstract linkages and interrelationships.

35. A system for controlling an agricultural operation, comprising: control-related elements, including one or more sensors that may sense one or more environmental conditions, and one or more devices that may effect the one or more environmental conditions; optionally, one or more variables, wherein the one or more variables and the control-related elements are collectively referred to as linkable entities; a control computer that manages sensor data and affects the state of the one or more hardware devices; and a machine executable program of instructions that provides for abstract linkages to be created among the linkable entities; wherein the control computer includes machine executable programs of instruction including a data manipulation process that can record sequences of environmental conditions, and display the sequences at a later time on a graphical user interface allowing for user manipulation.

36. A system for controlling an agricultural operation, comprising: control-related elements, including one or more sensors that may sense one or more environmental conditions, and one or more devices that may effect the one or more environmental conditions;
optionally, one or more variables, wherein the one or more variables and the control related elements are collectively referred to as linkable entities; a control computer that manages sensor data and affects the state of the one or more hardware devices; and a machine executable program of instructions that provides for abstract linkages to be created among the linkable entities; wherein the relationships and abstract linkages among the control-related elements can be reconfigured to be dependent upon any of the linkable entities.

37. A method for controlling an agricultural operation, comprising: sensing, by one or more sensors, one or more environmental conditions; storing data corresponding to the one or more environmental conditions in a control computer that manages sensor data and may affect the state of one or more devices, wherein the one or more sensors and one or more devices are referred to as control related elements; maintaining, in the control computer, a list of linkable entities, wherein the linkable entities are comprised of control-related elements and zero or more variables; and processing machine executable programs of instructions including a control process that provides for abstract linkages and relationships to be implemented among the linkable entities.

38. An article of manufacture embodying a program of instructions executable by a machine, the program of instructions including instructions for: sensing, by one or more sensors, one or more environmental conditions; storing data corresponding to the one or more environmental conditions in a computer that manages sensor data and may affect the state of one or more devices, wherein the one or more sensors and one or more devices are referred to as control-related elements; maintaining, in the computer, a list of linkable entities, wherein the linkable entities are comprised of control-related elements and zero or more variables; and executing a control process that provides for abstract linkages and relationships to be implemented among the linkable entities.
